(19) United States
(12) Patent Application Publication
(10) Pub. No.: US 2008/0027695 A1
(43) Pub. Date: Jan. 31, 2008

(54) APPARATUS AND METHOD FOR COMPUTER MODELING RESPIRATORY DISEASE

(75) Inventors: Ganesh BALGI, Cupertino, CA (US); Jason Chan, Palo Alto, CA (US); Ananth Kadambi, Daly City, CA (US); Thomas S. Paterson, Redondo Beach, CA (US); Leif Wennerberg, Mountain View, CA (US)

Correspondence Address: ENTELOS, INC.;c/o Law Offices of Karen E. Flick, P.O. Box 515, El Granada, CA, 94018-0515, US

(73) Assignee: Entelos, Inc.

(21) Appl. No.: 11/681,655

(22) Filed: Mar. 2, 2007

Related U.S. Application Data
(60) Provisional application No. 60/779,240, filed on Mar. 3, 2006.

(51) Int. Cl. G06G 7/60

(52) U.S. Cl. 703/11

(57) ABSTRACT

The invention encompasses novel methods for developing a computer model of a mammalian respiratory system. In particular, the models include representations of biological processes associated with obstruction of the respiratory system with constriction of the respiratory system. The invention also encompasses computer models of respiratory systems, methods of simulating respiratory systems and computer systems for simulating respiratory systems.

### I. CROSS-REFERENCE TO RELATED APPLICATIONS

This application claims the benefit of U.S. provisional patent application No. 60/779,240, filed 3 Mar. 2006, incorporated herein by reference in its entirety.

### II. INTRODUCTION

A. Field of the Invention

The present invention relates generally to the field of simulating mammalian respiratory systems.

B. Background of the Invention

In 2003 it was estimated that 20 million Americans currently have asthma and accounted for an estimated 24.5 million lost work days in adults. The annual direct health care cost of asthma is approximately $11.5 billion; indirect costs (e.g. lost productivity) add another $4.6 billion, for a total of $16.1 billion dollars. While asthma cannot be cured, it can be managed generally by taking prescribed medicines that open the lung airways and treat inflammation. Two classes of medications have been used to treat asthma—anti-inflammatory agents and bronchodilators. Anti-inflammatory drugs interrupt the development of bronchial inflammation and have a preventive action. They may also modify or terminate ongoing inflammatory reactions in the airways. These agents include corticosteroids, cromolyn sodium, and other anti-inflammatory compounds. A new class of anti-inflammatory medications known as leukotriene modifiers, which work in a different way by blocking the activity of chemicals called leukotrienes that are involved in airway inflammation have recently come on the market.

There exists a well defined need for novel and effective therapies for treating respiratory and lung ailments that cannot presently be treated, or at least for which no therapies are available that are effective and devoid of significant detrimental side effects. This is the case of ailments afflicting the respiratory tract, and more particularly the lung and the lung airways, including respiratory difficulties, asthma, bronchoconstriction, lung inflammation and allergies, depletion or hyposecretion of surfactant, etc. Moreover, there is a definite need for treatments that have prophylactic and therapeutic applications, and require low amounts of active agents, which makes them both less costly and less prone to detrimental side effects.

### SUMMARY OF THE INVENTION

One aspect of the invention provides methods for developing a model of a respiratory system of a mammal, said method comprising: (a) identifying one or more biological processes associated with obstruction of the respiratory system; (b) identifying one or more biological processes associated with constriction of the respiratory system; (c) mathematically representing each biological process to generate one or more dynamic representations of a biological process associated with obstruction of the respiratory system and one or more representations of a biological process associated with constriction of the respiratory system; and (d) combining the representations of biological processes to form a model of the respiratory system. Preferably the model of a respiratory system is a computer model of the respiratory system. The biological processes associated with obstruction of respiratory system include, but are not limited to, biological processes associated with edema and biological processes associated with mucus. Biological process associated with edema can be responsive to epithelial denuding, vascular permeability, and/or inflammatory mediators. Biological processes associated with mucus secretion can be responsive to epithelial denuding, vascular permeability, mucus secretion, and/or inflammatory mediators.

In certain implementations of the invention, the method for developing a model of a respiratory system further comprises identifying one or more biological processes associated with biomechanical remodeling of the respiratory system; and mathematically representing each biological process associated with biomechanical remodeling to generate one or more representations of a biological process associated with biomechanical remodeling. The biological process associated with biomechanical remodeling of the respiratory system can be a biological process associated with tissue hyperplasia, a biological process associated with airway compliance or a biological process associated with tissue compliance.

Yet another aspect of the invention provides computer models of a respiratory system of a mammal comprising one or more mathematical representations of a biological process associated with obstruction of the respiratory system; one or more mathematical representations of a biological process associated with constriction of the respiratory system; and a set of mathematical relationships between the representations of biological processes to form the model. Optionally, the computer model can also comprise one or mathematical representations of a biological process associated with biomechanical remodeling of the respiratory system.

Another aspect of the invention provides computer-readable media having computer-readable instructions stored thereon that, upon execution by a processor, cause the processor to simulate a respiratory system of a mammal, and further wherein the instructions comprise: (a) mathematically representing one or more biological processes associated with obstruction of the respiratory system of the mammal, wherein at least one representation varies in response to other biological processes; (b) mathematically representing one or more biological processes associated with constriction of the respiratory system of the mammal; and (c) defining a set of mathematical relationships between the representations of biological processes to form a model of the respiratory system. The instructions can further comprise mathematically representing one or more biological processes associated with biomechanical remodeling of the respiratory system. Alternatively, or in addition, the instructions further can comprise accepting user input specifying one or more parameters or variables associated with one or more of the mathematical representations. In certain implementations of the invention, the instructions may also comprise applying a virtual protocol to the model of the respiratory system. Exemplary virtual protocols include, but are not limited to, therapeutic regimens, diagnostic procedures, passage of time, exposure to environmental toxins, and physical exercise. In another implementation, the instructions can include defining one or more virtual patients.

An aspect of the invention provides methods of simulating a respiratory system of a mammal, said method comprising executing a computer model of a respiratory system. Methods of simulating a respiratory system can further comprise applying a virtual protocol to the computer model to generate a set of outputs representing a phenotype of the biological system. The phenotype can represent a normal state or a diseased state. In certain implementations, the methods further can include accepting user input specifying one or more parameters or variables associated with one or more mathematical representations prior to executing the computer model. Preferably, the user input comprises a definition of a virtual patient or a definition of a virtual protocol.

Yet another aspect of the invention provides systems comprising (a) a processor including computer-readable instructions stored thereon that, upon execution by a processor, cause the processor to simulate a respiratory system of a mammal; (b) a first user terminal, the first user terminal operable to receive a user input specifying one or more parameters associated with one or more mathematical representations defined by the computer readable instructions; and (c) a second user terminal, the second user terminal operable to provide the set of outputs to a second user. The instruction comprise (i) mathematically representing one or more biological processes associated with obstruction of the respiratory system of the mammal; (ii) mathematically representing one or more biological processes associated with constriction of the respiratory system of the mammal; (iii) defining a set of mathematical relationships between the representations of biological processes associated with obstruction and representations of biological processes associated with constriction; and (iv) applying a virtual protocol to the set of mathematical relationships to generate a set of outputs.

It will be appreciated by one of skill in the art that the implementations summarized above may be used together in any suitable combination to generate implementations not expressly recited above and that such implementations are considered to be part of the present invention.

### III. BRIEF DESCRIPTION OF THE DRAWINGS

An overview of the methods used to develop computer models of the respiratory system is illustrated in FIG. 1.

FIG. 2 provides a diagrammatic summary of an exemplary model of the respiratory system.

FIG. 3 illustrates an exemplary Summary Diagram that links modules for airway obstruction, airway constriction and other related biological processes.

FIG. 4 provides an exemplary Effect Diagram illustrating the contributions of edema, mucus and airway smooth muscle to pulmonary function as measured by FEV1.

FIG. 5 provides an exemplary Effect Diagram illustrating population dynamics and mediator production of epithelium and sensory nerves.

FIG. 6 provides an exemplary Effect Diagram illustrating macrophage population dynamics.

FIG. 7 illustrates mediator production by macrophages.

FIG. 8 provides an exemplary Effect Diagram illustrating regulation of monocyte/macrophage extravasation/recruitment.

FIG. 9 provides an exemplary Effect Diagram illustrating mast cell population dynamics.

FIG. 10 illustrates mediator production by mast cells.

FIG. 11 provides an exemplary Effect Diagram illustrating regulation of mast cell extravasation/recruitment.

FIG. 12 provides an exemplary Effect Diagram illustrating eosinophil population dynamics.

FIG. 13 illustrates mediator production by eosinophils.

FIG. 14 provides an exemplary Effect Diagram illustrating regulation of eosinophil extravasation/recruitment.

FIG. 15 provides an exemplary Effect Diagram illustrating basophil population dynamics.

FIG. 16 illustrates mediator production by basophils.

FIG. 17 provides an exemplary Effect Diagram illustrating regulation of basophil extravasation/recruitment.

FIG. 18 provides an exemplary Effect Diagram illustrating neutrophil population dynamics.

FIG. 19 illustrates mediator production by neutrophils.

FIG. 20 provides an exemplary Effect Diagram illustrating regulation of neutrophil extravasation/recruitment.

FIG. 21 provides an exemplary Effect Diagram illustrating T cell population dynamics.

FIG. 22 illustrates mediator production by T cells.

FIG. 23 provides an exemplary Effect Diagram illustrating regulation of T cell extravasation/recruitment.

FIG. 24 provides an exemplary Effect Diagram illustrating binding kinetics of antigen, IgE and Fcε receptors in the context of the model of the respiratory system.

FIG. 25 provides an exemplary Effect Diagram illustrating regulation of endothelial adhesion molecules expression in the context of the model of the respiratory system.

FIGS. 26 and 27 provide exemplary Effect Diagrams illustrating application of a virtual protocol representing CysLT receptor antagonists to a model of the respiratory system. FIG. 26 illustrates the modifications to the model resulting from the antagonist therapy and pharmacokinetics of CysLT receptor antagonists. FIG. 27 illustrates the effects of CysLT receptor antagonist pharmacodynamics in the context of the model of the respiratory system.

FIG. 28 provides exemplary Effect Diagrams illustrating application of virtual protocols representing pharmacokinetics of short- and long-acting beta adrenergic agonist therapies to the model of the respiratory system.

FIG. 29 provides exemplary Effect Diagrams illustrating application of a virtual protocols representing changes to the model of the respiratory system with implementation of glucocorticosteroids and histamine-receptor antagonist therapies.

FIG. 30 provides exemplary Effect Diagrams illustrating application of a virtual protocol representing soluble IL-4 receptor therapy, anti-IL-5 mAb therapy, and anti-IL-13 mAb therapy to the model of the respiratory system.

FIGS. 31, 32 and 33 provide exemplary Effect Diagrams illustrating application of a virtual protocol representing PDE4 (cyclic phosphodiesterase 4) inhibitor therapy to a model of the respiratory system. FIG. 31 illustrates the model representation of the pharmacokinetic of PDE4 inhibitor. FIGS. 32 and 33 illustrate the effects of PDE4 inhibitor pharmacodynamics in the context of the model of the respiratory system.

### IV. DETAILED DESCRIPTION

A. Overview

The invention encompasses novel methods for developing a computer model of a mammalian respiratory system. In particular, the models include representations of biological processes associated with obstruction of the respiratory system and representations of biological processes associated with constriction of the respiratory system. The invention also encompasses computer models of respiratory systems, methods of simulating respiratory systems and computer systems for simulating respiratory systems.

B. Definitions

A “biological system” can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardiovascular system.

The term “biological component” refers to a portion of a biological system. A biological component that is part of a biological system can include, for example, an extra-cellular constituent, a cellular constituent, an intra-cellular constituent, or a combination of them. Examples of suitable biological components, include, but are not limited to, metabolites, DNA, RNA, proteins, surface and intracellular receptors, enzymes, lipid molecules (i.e., free cholesterol, cholesterol ester, triglycerides, and phospholipid), hormones, cells, organs, tissues, portions of cells, tissues, or organs, subcellular organelles, chemically reactive molecules like H⁺, superoxides, ATP, as well as, combinations or aggregate representations of these types of biological variables. In addition, biological components can include therapeutic agents such as β₂-agonists (such as albuterol or formoterol), methylxanthines, corticosteroids (such as beclomethasone or dexamethasone), mast cell stabilizers, leukotriene modifiers, and anticholinergics, as well as combination therapies (e.g., Combivent®, which is a combination of albuterol sulfate and ipratropium bromide, or Advair®, which is a combination of fluticasone propionate and salmeterol xinafoate).

The term “biological process” is used herein to mean an interaction or series of interactions between biological components. Examples of suitable biological processes, include, but are not limited to, activation, apoptosis or recruitment of certain cells, such as macrophages, mucus secretion, vascular permeability, mediator production, and the like. The term “biological process” can also include a process comprising one or more therapeutic agents, for example the process of binding a therapeutic agent to a cellular mediator. Each biological variable of the biological process can be influenced, for example, by at least one other biological variable in the biological process by some biological mechanism, which need not be specified or even understood.

The term “parameter” is used herein to mean a value that characterizes the interaction between two or more biological components. Examples of parameters include affinity constants, Kₘ, K_{d}, k_{cat}, half life, or net flux of cells, such macrophages or neutrophils, into airway tissues.

The term “variable,” as used herein refers to a value that characterizes a biological component. Examples of variables include the total number of T cells, the number of active or inactive macrophages, and the concentration of a mediator, such as bradykinin or ROS.

The term “phenotype” is used herein to mean the result of the occurrence of a series of biological processes. As the biological processes change relative to each other, the phenotype also undergoes changes. One measurement of a phenotype is the level of activity of variables, parameters, and/or biological processes at a specified time and under specified experimental or environmental conditions.

A phenotype can include, for example, the state of an individual cell, an organ, a tissue, and/or a multi-cellular organism. Organisms useful in the methods and models disclosed herein include animals. The term “animal” as used herein includes mammals, such as humans. A phenotype can also include, but is not limited to, behavior of the system as a whole, as measured by FEV1. The conditions defined by a phenotype can be imposed experimentally, or can be conditions present in a patient type. For example, a phenotype of FEV1 can include amount of contractile stimulatory mediators and regulators of vascular permeability for a healthy subject. In another example, the phenotype of FEV1 can include increased amounts of contractile stimulatory mediators for a mildly asthmatic patient. In yet another example, the phenotype can include the amounts of contractile stimulatory mediators for a patient being treated with one or more of the therapeutic agents.

The term “disease state” is used herein to mean a phenotype where one or more biological processes are related to the cause or the clinical signs of the disease. For example, a disease state can be the state of a diseased cell, a diseased organ, a diseased tissue, or a diseased multi-cellular organism. Examples of diseases that can be modeled include asthma, chronic bronchitis, chronic obstructive pulmonary disease, emphysema, cystic fibrosis, respiratory failure, pulmonary edema, pulmonary embolism, pulmonary hypertension, pneumonia, tuberculosis (TB), and lung cancer. A diseased multi-cellular organism can be, for example, an individual human patient, a group of human patients, or the human population as a whole. A diseased state can also include, for example, a defective enzyme or the overproduction of an inflammatory mediator.

The term “simulation” is used herein to mean the numerical or analytical integration of a mathematical model. For example, simulation can mean the numerical integration of the mathematical model of the phenotype defined by the equation, i.e., dx/dt=f(x, p, t).

The term “biological characteristic” is used herein to refer to a trait, quality, or property of a particular phenotype of a biological system. For example, biological characteristics of a particular disease state include clinical signs and diagnostic criteria associated with the disease. The biological characteristics of a biological system can be measurements of biological variables, parameters, and/or processes. Suitable examples of biological characteristics associated with a disease state of the respiratory system include, but are not limited to, measurements of forced expiratory volume, airway compliance, or histamine levels.

The term “computer-readable medium” is used herein to include any medium which is capable of storing or encoding a sequence of instructions for performing the methods described herein and can include, but not limited to, optical and/or magnetic storage devices and/or disks, and carrier wave signals.

The term “dynamic” as used herein in connection with biological processes refers to varying the character or extent of the interactions of biological components within a biological process to reflect changing biological conditions.

C. Methods of Developing Models of Mammalian Respiratory Systems

A computer model can be designed to model one or more biological processes or functions. The computer model can be built using a “top-down” approach that begins by defining a general set of behaviors indicative of a biological condition, e.g. a disease. The behaviors are then used as constraints on the system and a set of nested subsystems are developed to define the next level of underlying detail. For example, given a behavior such as cartilage degradation in rheumatoid arthritis, the specific mechanisms inducing the behavior are each be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior. Specifically, the model is capable of modeling biological processes that can be manipulated by a drug or other therapeutic agent.

An overview of the methods used to develop computer models of the respiratory system is illustrated in FIG. 1. The methods typically begin by identifying one or more biological processes associated with airway constriction and one or more biological processes associated with airway obstruction. The identification of biological process associated with airway constriction or airway obstruction can be informed by data relating to the respiratory system or any portion thereof. Optionally, the method can also comprise the step of identifying one or biological processes associated with biomechanical remodeling of the respiratory system. The method next comprises the step of mathematically representing each identified biological process. The biological processes can be mathematically represented in any of a variety of manners. Typically, the biological process is defined by the equation, i.e., dx/dt=f(x, p, t), as described below. The representations of biological processes associated with airway constriction and with airway obstruction are combined, thus forming predictive models of the respiratory system. The methods may further include the steps of identifying and mathematically representing one or more biological processes associated with airway compliance, tissue compliance and/or tissue hyperplasia of the respiratory system.

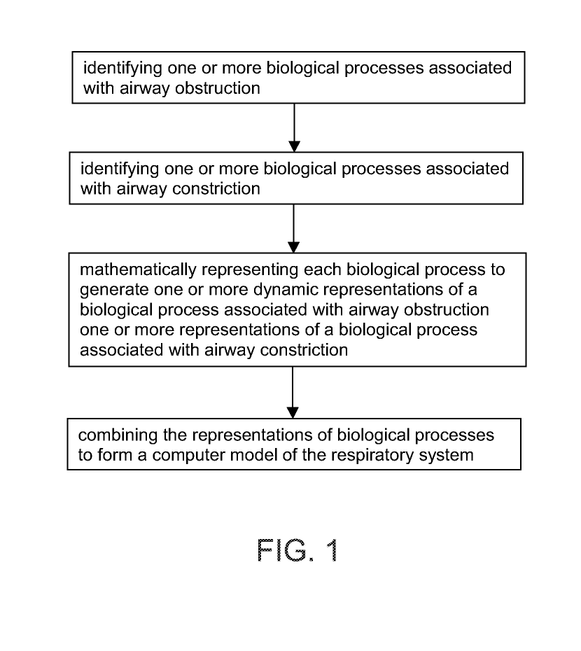

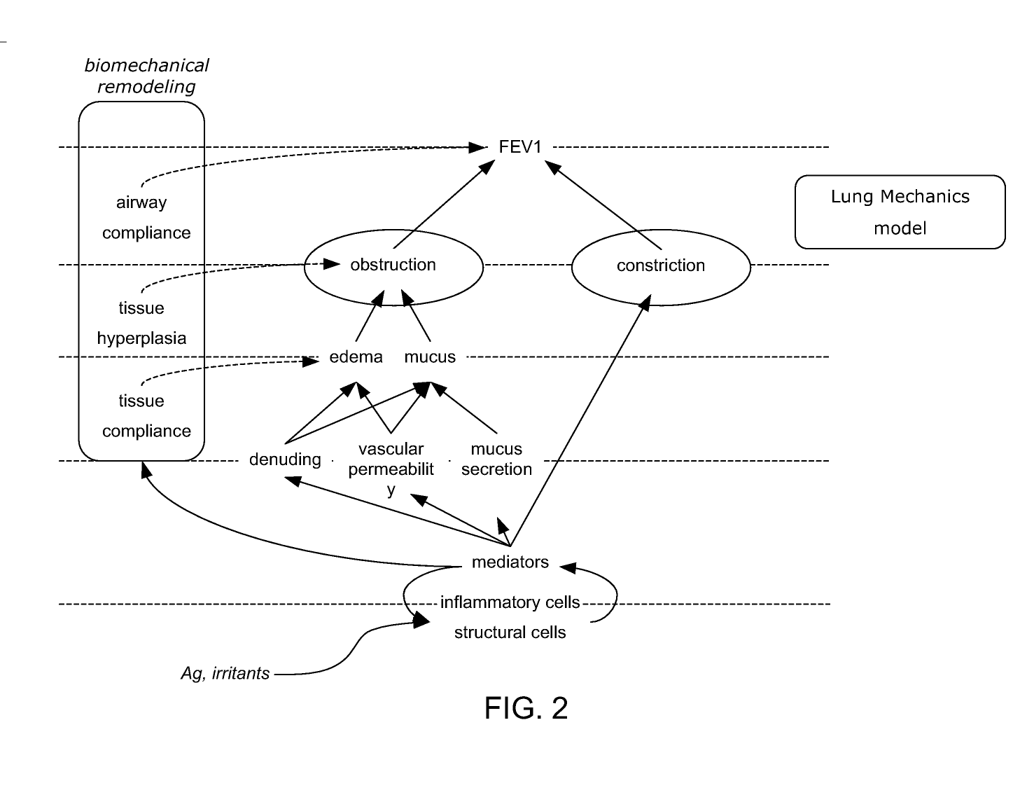

FIG. 2 illustrates various biological processes that relate to the respiratory system of a mammal. In one implementation of the invention, the primary measure of the performance of the respiratory system is the amount of air a subject can expire in one second (forced expiratory volume in 1 second, FEV1). The FEV1 is a nearly direct measure of the mechanics of the lung, as described by Lambert (J Biomech Eng., 111(3):200-5 (1989)). Two primary biological processes affect function of the respiratory system: airway constriction and airway obstruction. Each of these processes is dynamically responsive to changes in the environment and the phenotype of a subject. Airway compliance may also affect the function of the respiratory system. Airway compliance refers to elasticity or stiffness of airway. Primarily, airway compliance is a measure of the parenchymal tethering of lungs within the body and relates the cross-sectional area of a section of the lung to transmural pressure within the lung.

In a preferred implementation of the invention, identifying a biological process associated with constriction comprises identifying a biological process related to smooth muscle contraction and/or smooth muscle shortening. The biological process associated with smooth muscle contraction may incorporate the interactions of one or more airway smooth muscle contractile stimuli and/or relaxation stimuli, such as ROS, methacholine, CysLT, endothelin 1, acetylcholine, histamine, TxA2, PGF2-α, PGD2, neurokinin A, substance P, bradykinin, by IL-5, GM-CSF, tryptase, IL-2, IFN-γ, β₂-adrenergic receptor (β₂-AR) agonist, the fraction of desensitized β₂-adrenergic receptors and PGE2.

In another preferred implementation of the invention, identifying a biological process associated with obstruction comprises identifying a biological process related to tissue hyperplasia, airway mucus and/or edema in the tissues of the respiratory system. Tissue hyperplasia is irreversible and has an essentially static effect on obstruction of the respiratory system in the context of simulations of respiratory function with a time scale of minutes, days or weeks. The effects of tissue hyperplasia may be relevant to simulations of respiratory function over long time periods such as years or decades.

Biological processes associated with airway mucus can comprise interactions of a variety of biological components such as luminal fluid, glucocorticosteroids, ROS, substance P, neurokinin, acetylcholine, β₂-AR agonist, the fraction of desensitized β₂-AR agonist receptor on mucus secreting cells, CysLT, PGD2, PGE2, PAF, histamine, bradykinin, chymase, methacholine and elastase.

Biological processes associated with airway edema can comprise interactions of a variety of biological components such as, denuded epithelium, ciliated epithelium, airway goblet cells, airway tissue fluid, tissue fluid pressure, vascular permeability, substance P, neurokinin A, acetylcholine, CysLT, PAF, histamine, bradykinin, ROS, methacholine, β₂-AR agonist and/or the fraction of desensitized β₂-AR agonist receptor. In addition, biological processes associated with airway edema can comprise interaction of biological components related to tissue compliance, which amplifies the magnitude of edema for a given change in vascular permeability. Tissue compliance refers to the elasticity of respiratory system tissue, and particularly describes the effects of irreversible enzymatic scarring of the tissue. As with, tissue hyperplasia, the effects of tissue compliance on edema are essentially static in the context of simulations of respiratory function with a time scale of minutes, days or weeks. The effects of tissue compliance can be relevant to simulations of pulmonary function over long time periods such as years or decades.

These biological processes with long time scales, i.e., airway compliance, tissue hyperplasia and tissue compliance, represent biomechanical remodeling of the respiratory system. Preferably, implementations of the invention will include biological processes associated with biomechanical remodeling, even for models that are intended only for short-term simulations.

Once one or more biological processes are identified in the context of the methods of the invention, each biological process is mathematically represented. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables describing levels or activities of various biological components of the biological system as well as levels or activities of combinations or aggregate repress

entations of the various biological components. In addition, variables can represent various stimuli that can be applied to the physiological system. The mathematical model(s) of the computer-executable software code represents the dynamic biological processes related to respiratory function. The form of the mathematical equations employed may include, for example, partial differential equations, stochastic differential equations, differential algebraic equations, difference equations, cellular automata, coupled maps, equations of networks of Boolean or fuzzy logical networks, etc.

In some embodiments, the mathematical equations used in the model are ordinary differential equations of the form:
dx/dt=f(x, p, t)
where x is an N dimensional vector whose elements represent the biological variables of the system, t is time, dx/dt is the rate of change of x, p is an M dimensional set of system parameters, and f is a function that represents the complex interactions among biological variables. In one implementation, the parameters are used to represent intrinsic characteristics (e.g., genetic factors) as well as external characteristics (e.g., environmental factors) for a biological system.

In some embodiments, the phenotype can be mathematically defined by the values of x and p at a given time. Once a phenotype of the model is mathematically specified, numerical integration of the above equation using a computer determines, for example, the time evolution of the biological variables x(t) and hence the evolution of the phenotype over time.

The representation of the biological processes are combined to generate a model of the respiratory system. Generation of models of biological systems are described, for example, in U.S. Pat. Nos. 5,657,255 and 5,808,918, entitled “Hierarchical Biological Modeling System and Method”; U.S. Pat. No. 5,914,891, entitled “System and Method for Simulating Operation of Biochemical Systems”; U.S. Pat. No. 5,930,154, entitled “Computer-based System and Methods for Information Storage, Modeling and Simulation of Complex Systems Organized in Discrete Compartments in Time and Space”; U.S. Pat. No. 6,051,029, entitled “Method of Generating a Display for a Dynamic Simulation Model Utilizing Node and Link Representations”; U.S. Pat. No. 6,069,629, entitled “Method of Providing Access to Object Parameters Within a Simulation Model”; U.S. Pat. No. 6,078,739, entitled “A Method of Managing Objects and Parameter Values Associated With the Objects Within a Simulation Model”; U.S. Pat. No. 6,539,347, entitled “Method of Generating a Display For a Dynamic Simulation Model Utilizing Node and Link Representations”; U.S. Pat. No. 6,983,237, entitled “Method and Apparatus for Conducting Linked Simulation Operations Utilizing a Computer-Based System Model”; and PCT publication WO 99/27443, entitled “A Method of Monitoring Values within a Simulation Model”.

The methods can further comprise methods for validating the computer models described herein. For example, the methods can include generating a simulated biological characteristic associated with a respiratory system of an animal, and comparing the simulated biological characteristic with a corresponding reference biological characteristic measured in a normal or diseased animal. The result of this comparison in combination with known dynamic constraints may confirm some part of the model, or may point the user to a change of a mathematical relationship within the model, which improves the overall fidelity of the model. Methods for validating the various models described herein are taught in U.S. Patent Publication 2002-0193979, entitled “Apparatus And Method For Validating A Computer Model, and in U.S. Pat. No. 6,862,561, entitled “Method and Apparatus for Computer Modeling a Joint”.

D. Computer Models of Mammalian Respiratory Systems

The invention provides computer models of a respiratory system of a mammal comprising one or more mathematical representations of a biological process associated with obstruction of the respiratory system; one or more mathematical representations of a biological process associated with constriction of the respiratory system; and a set of mathematical relationships between the representations of biological processes to form the model. Optionally, the computer model can also comprise one or mathematical representations of a biological process associated with biomechanical remodeling of the respiratory system.

The methods of developing models of the respiratory system described above may be used to generate a model for simulating respiratory systems. In such a case, the simulation model may include hundreds or even thousands of objects, each of which may include a number of parameters. In order to perform effective “what-if” analyses using a simulation model, it is useful to access and observe the input values of certain key parameters prior to performance of a simulation operation, and also possibly to observe output values for these key parameters at the conclusion of such an operation. As many parameters are included in the expression of, and are affected by, a relationship between two objects, a modeler may also need to examine certain parameters at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

The created computer model represents biological processes at multiple levels and then evaluates the effect of the biological processes on biological processes across all levels. Thus, the created computer model provides a multi-variable view of a biological system. The created computer model also provides cross-disciplinary observations through synthesis of information from two or more disciplines into a single computer model or through linking two computer models that represent different disciplines.

An exemplary, computer model reflects a particular biological system, e.g., the respiratory system, and anatomical factors relevant to issues to be explored by the computer model. The level of detail incorporated into the model is often dictated by a particular intended use of the computer model. For example, biological components being evaluated often operate at a subcellular level; therefore, the subcellular level can occupy the lowest level of detail represented in the model. The subcellular level includes, for example, biological components such as DNA, mRNA, proteins, chemically reactive molecules, and subcellular organelles. Similarly, the model can be evaluated at the multicellular level or even at the level of a whole organism. Because an individual biological system, i.e. a single human, is a common entity of interest with respect to the ultimate effect of the biological components, the individual biological system (e.g., represented in the form of clinical outcomes) is the highest level represented in the system. Disease processes and therapeutic interventions are introduced into the model through changes in parameters at lower levels, with clinical outcomes being changed as a result of those lower level changes, as opposed to representing disease effects by directly changing the clinical outcome variables.

The level of detail reported to a user can vary depending on the level of sophistication of the target user. For a healthcare setting, especially for use by members of the public, it may be desirable to include a higher level of abstraction on top of a computer model. This higher level of abstraction can show, for example, major physiological subsystems and their interconnections, but need not report certain detailed elements of the computer model—at least not without the user explicitly deciding to view the detailed elements. This higher level of abstraction can provide a description of the virtual patient's phenotype and underlying physiological characteristics, but need not include certain parametric settings used to create that virtual patient in the computer model. When representing a therapy, this higher level of abstraction can describe what the therapy does but need not include certain parametric settings used to simulate that therapy in the computer model. A subset of outputs of the computer model that is particularly relevant for subjects and doctors can be made readily accessible.

In one implementation, the computer model is configured to allow visual representation of mathematical relations as well as interrelationships between variables, parameters, and biological processes. This visual representation includes multiple modules or functional areas that, when grouped together, represent a large complex model of a biological system.

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; and U.S. Pat. No. 6,069,629, issued May 30, 2000, titled “Method of Providing Access to Object Parameters Within a Simulation Model”. An example of simulation modeling software is found in U.S. Pat. No. 6,078,739.

Various Diagrams can be used to illustrate the dynamic relationships among the elements of the model of the respiratory system. Examples of suitable diagrams include Effect and Summary Diagrams.

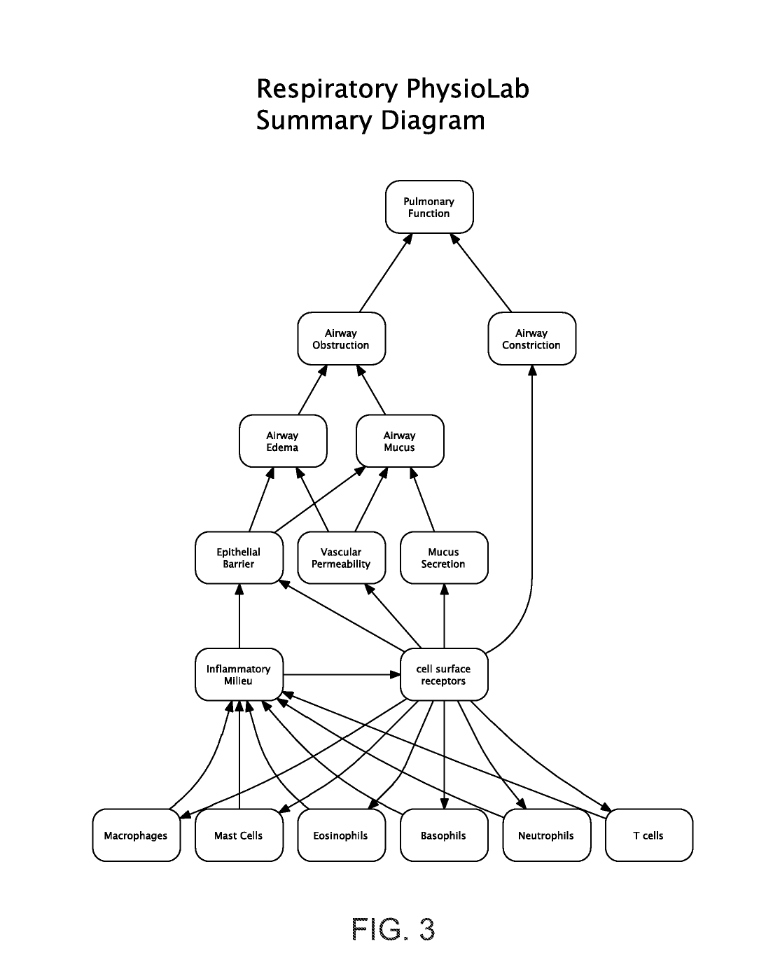

A Summary Diagram can provide an overview of the various pathways modeled in the methods and models described herein. For example, the Summary Diagram illustrated in FIG. 3 provides an overview of pathways that can affect pulmonary function, as measured by FEV1. The Summary Diagram can also provide links to individual modules of the model. The modules model the relevant components of the phenotype through the use of “state” and “function” nodes whose relations are defined through the use of diagrammatic arrow symbols. Thus, the complex and dynamic mathematical relationships for the various elements of the phenotype are easily represented in a user-friendly manner. In this manner, a normal phenotype can be represented.

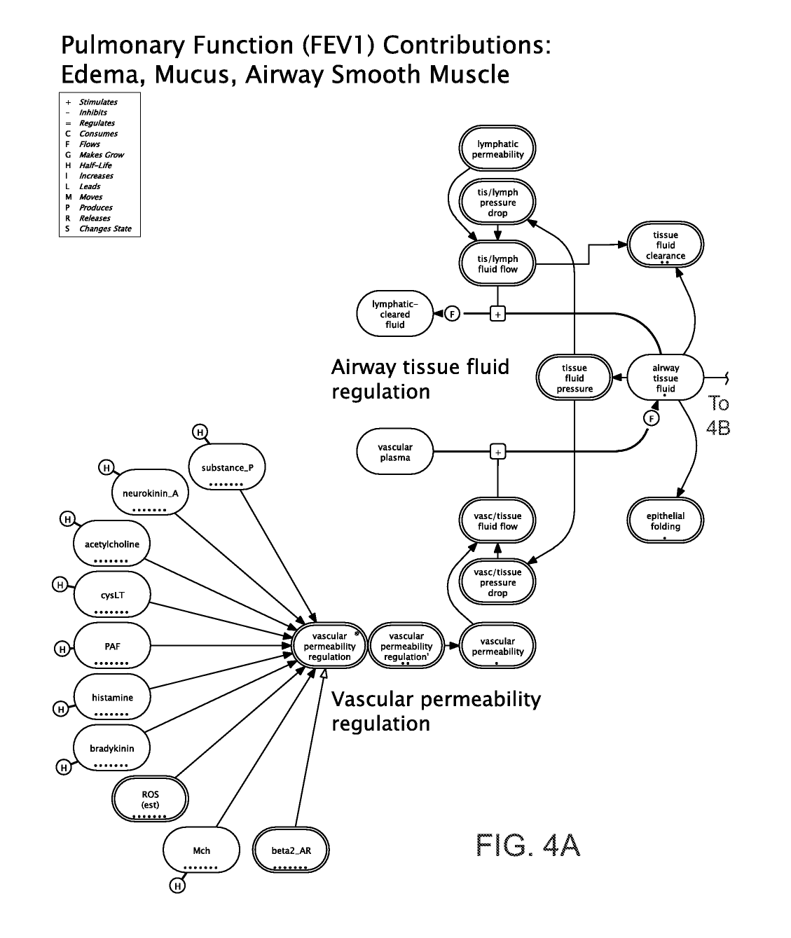

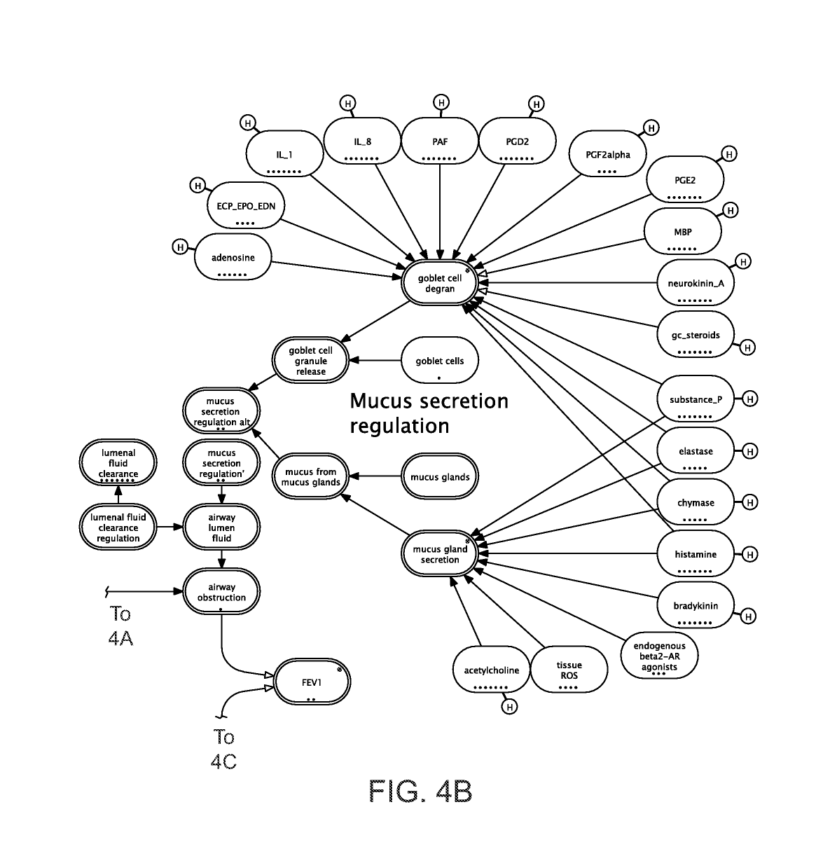

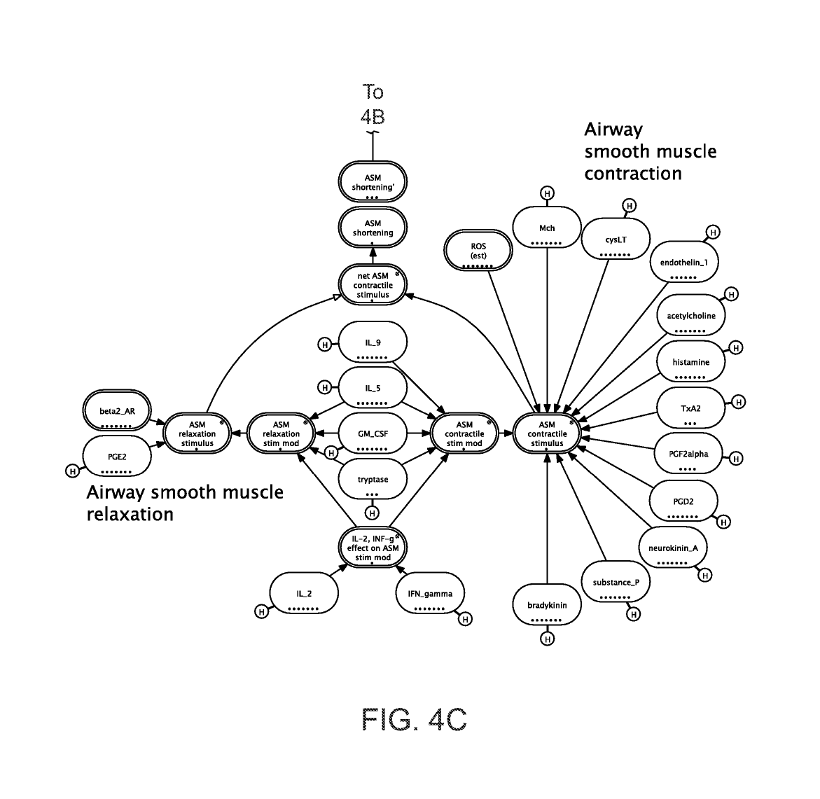

An Effect Diagram can be a visual representation of the model equations and illustrate the dynamic relationships among the elements of the model. FIG. 4 illustrates an example of an Effect Diagram, in which airway obstruction and airway smooth muscle (ASM) shortening are described. The Effect Diagram is organized into modules, or functional areas, which when grouped together represent the large complex physiology of the phenotype being modeled.

State and function nodes show the names of the variables they represent and their location in the model. The arrows and modifiers show the relationship of the state and function nodes to other nodes within the model. State and function nodes also contain the parameters and equations that are used to compute the values of the variables the represent in simulated experiments. In some embodiments, the state and function nodes are represented according to the method described in U.S. Pat. No. 6,051,029, entitled “Method of generating a Display for a Dynamic Simulation Model Utilizing Node and Link Representations.” Further examples of state and function nodes are further discussed below.

State nodes are represented by single-border ovals and represent variables in the system, the values of which are determined by the cumulative effects of inputs over time (see, e.g., FIG. 4). “Input” refer to any parameter that can affect the variable being modeled by the state node. For example, input for a state node representing tissue inactive macrophage can be macrophage recruitment or circulating inactive monocytes. State node values are defined by differential equations. The predefined parameters for a state node include its initial value (S₀) and its status. In some embodiments, state nodes can have a half-life. In these embodiments, a circle containing an “H” is attached to the node that has a half-life.

Function nodes are represented by double-border ovals and represent variables in the system, the values of which, at any point in time, are determined by inputs at the same point in time. Function nodes are defined by algebraic functions of their inputs. The predefined parameters for a function node include its initial value (F₀) and its status. Setting the status of a node effects how the value of the node is determined. The status of a state or function node can be: 1) Computed, i.e., the value is calculated as a result of its inputs; 2) Specified-Locked, i.e., the value is held constant over time; or 3) Specified Data, i.e., the value varies with time according to predefined data points.

State and function nodes can appear more than once in the module diagram as alias nodes. Alias nodes are indicated by one or more dots (see, e.g., state node “ASM contractile stimulus” in FIG. 3). State and Function nodes are also defined by their position, with respect to arrows and other nodes, as being either source nodes (S) or target nodes (T). Source nodes are located at the tails of arrows and target nodes are located at the heads of arrows. Nodes can be active or inactive.

Arrows link source nodes to target nodes and represent the mathematical relationship between the nodes. Arrows can be labeled with circles that indicate the activity of the arrow. A key to the annotations in the circles is located in the upper left corner of each module Diagrams. If an arrowhead is solid, the effect is positive. If the arrowhead is hollow, the effect is negative. For further description of arrow types, arrow characteristics, and arrow equations, see, e.g., U.S. Pat. No. 6,051,029, U.S. Pat. No. 6,069,629, U.S. Pat. No. 6,078,739, and U.S. Pat. No. 6,539,347.

Referring to FIG. 4, airway obstruction and airway constriction (smooth muscle shortening) combine to define respiratory function, preferably as measured by FEV1. Airway obstruction is a function of airway edema (tissue fluid) and airway mucus. Airway mucus in turn is a function of both mucus secretion and lumenal fluid clearance. Mucus secretion is affected by mucus production by mucus glands and goblet cell granule release. Mucus secretion, in turn is regulated by one or more of substance P, elastase, chymase, histamine, bradykinin, endogenous β₂-AR agonists, tissue ROS, and acetylcholine. Goblet cell granule release is responsive to one or more of adenosine, ECP, EPO, EDN, IL-1, IL-8, PAF, PGD2, PGF-2α, PGE2, MBP, neurokinin A, glucocorticoid steroids, substance P, elastase, chymase, and histamine. Airway edema is caused by fluid in airway tissue. The fluid moves in a regulated manner from vascular plasma to airway tissue and ultimately clears to the lymphatic system. Clearance and tissue fluid is affected by tissue fluid pressure and the flow rate of fluid from the tissue to lymph, which in turn is affected by the pressure drop between airway tissue and the lymph and lymphatic permeability. The flow of fluid from the vascular plasma to airway tissue is responsive to the pressure drop between the vascular and airway tissues and to vascular permeability. Vascular permeability, in turn, is regulated by one or more of substance P, neurokinin A, acetylcholine, CysLT, PAF, histamine, bradykinin, ROS, methacholine, β₂-AR agonist and the fraction of desensitized β₂-AR agonist receptors.

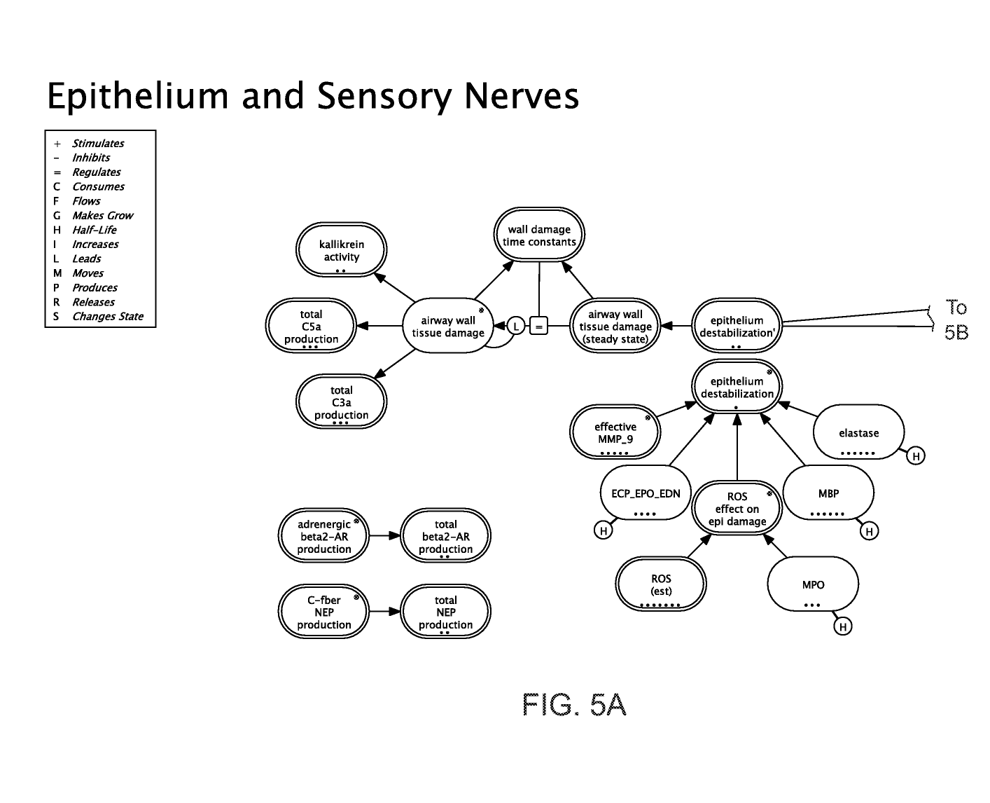

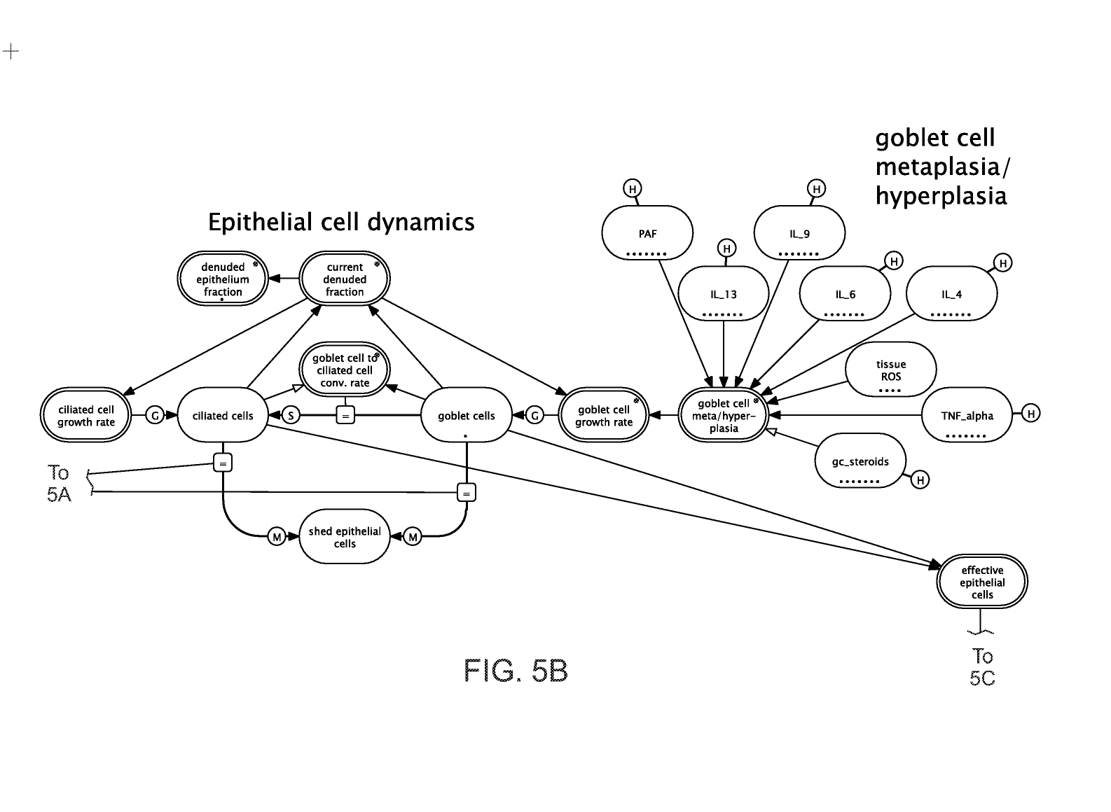

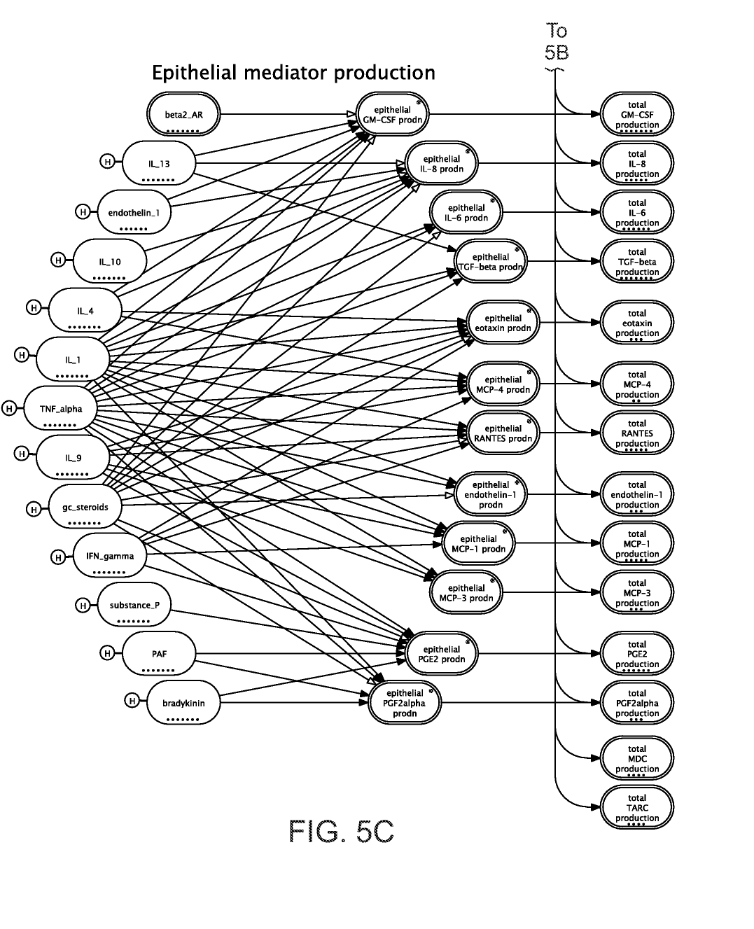

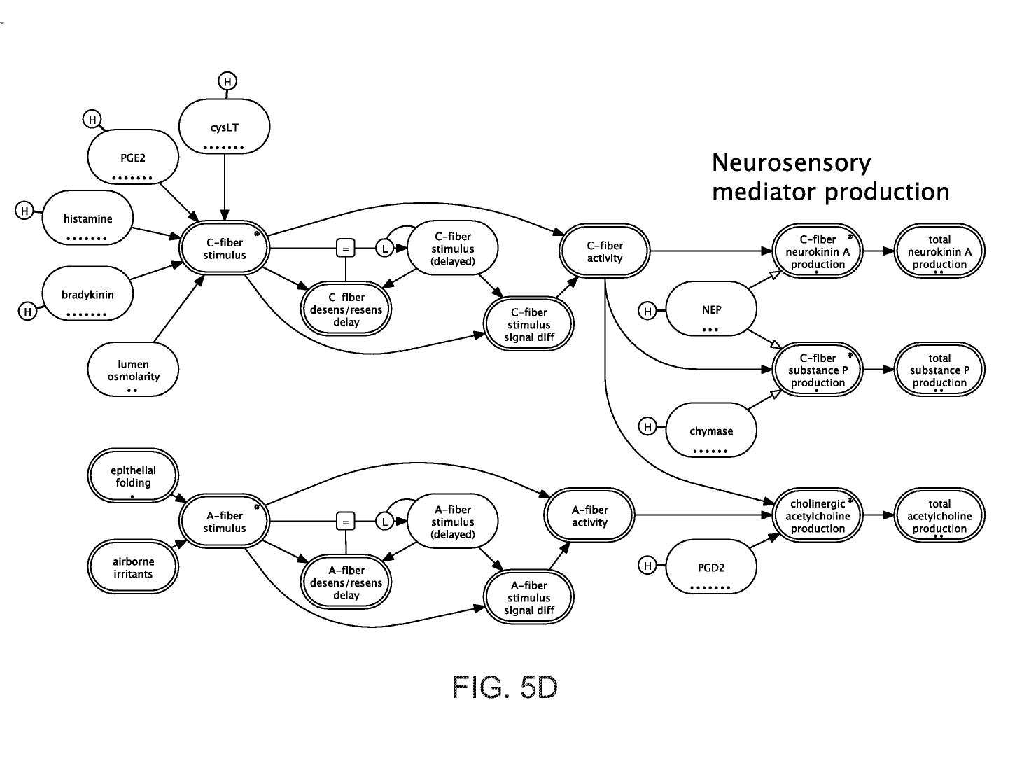

Both airway edema and airway mucus are responsive to the population of epithelial cells. FIG. 5 provides an Effect Diagram illustrating epithelial cell dynamics. Airway goblet cells become airway ciliated epithelial cells at a regulated conversion rate. Goblet cell growth rate is at least partially responsive to goblet cell metaplasia and hyperplasia, which is responsive to one or more of PAF, IL-13, IL-9, IL-6, IL-4, tissue ROS, TNF-α, and glucocorticoid steroids. The population of both airway goblet cells and airway ciliated epithelial cells are directly related to shedding of epithelial cells and the fraction of denuded epithelium. The rate of epithelial shedding is responsive to epithelium destabilization, which in turn is responsive to one or more of ECP, EPO, EDN, MMP-9, elastase, epithelial MBP and the net ROS effect. The net ROS effect is related to ROS binding and MPO receptor binding. Epithelium destabilization, in addition to affecting epithelial shedding rates, also affects the steady state measure of airway wall tissue damage. Airway tissue wall damage also positively affects at least one of kallikrein activity, total C5a production and total C3a production.

FIG. 5 also illustrates mediator production by epithelial and nerve cells. For example, the effective epithelial cell population, as represented by both airway goblet cells and airway ciliated epithelial cells affects one or more of total GM-CSF, IL-8, IL-6, TGF-β, eotaxin, MCP-4, RANTES, endothelin-1, MCP-1, MCP-3, PGE2, MDC, TARC, and PGF2α production. Sensory nerve activity, as represented by C-fiber activity and A-fiber activity, affect the production of neurokinin A, substance P and acetylcholine.

Airway constriction is a function of the amount of airway smooth muscle shortening, which in turn is responsive to airway smooth muscle contractile stimuli and airway smooth muscle relaxation stimuli. Airway smooth muscle contractile stimuli include one or more of ROS, methacholine, CysLT, endothelin 1, acetylcholine, histamine, TxA2, PGF2-α, PGD2, neurokinin A, substance P and bradykinin. Contractile stimulus is also modulated by IL-5, GM-CSF, tryptase, IL-2 and interferon gamma. Airway smooth muscle relaxation stimuli include β₂-AR agonist, PGE2, and the fraction of desensitized β₂-AR agonist receptors. Further, relaxation stimulus is also modulated by at least one of IL-5, GM-CSF, tryptase, IL-2 and interferon gamma.

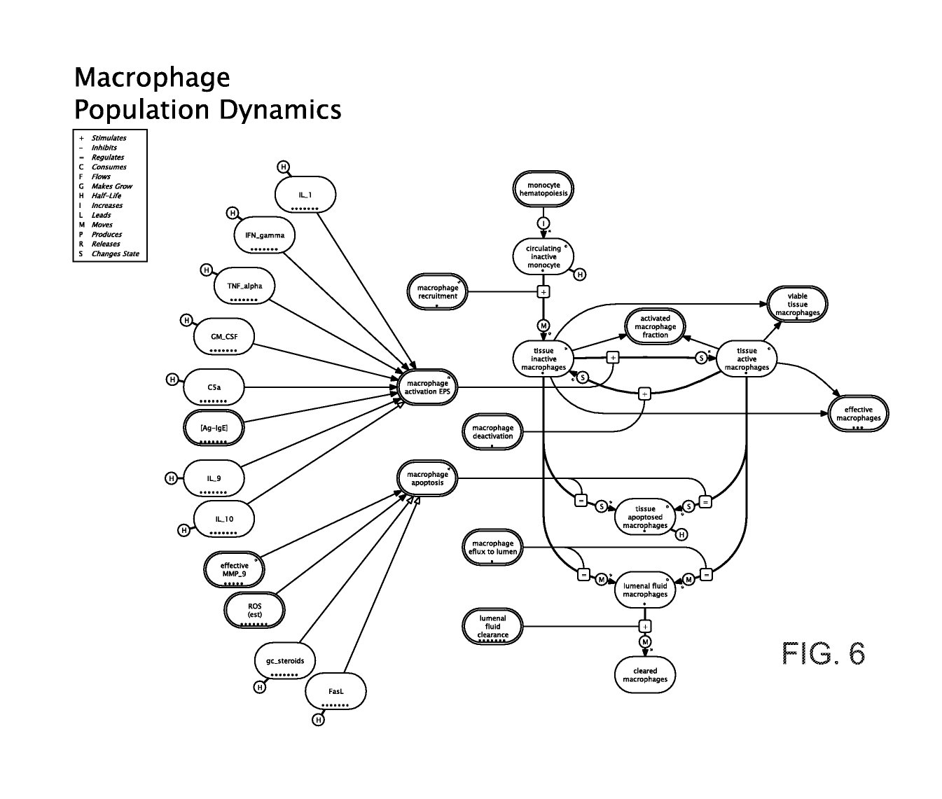

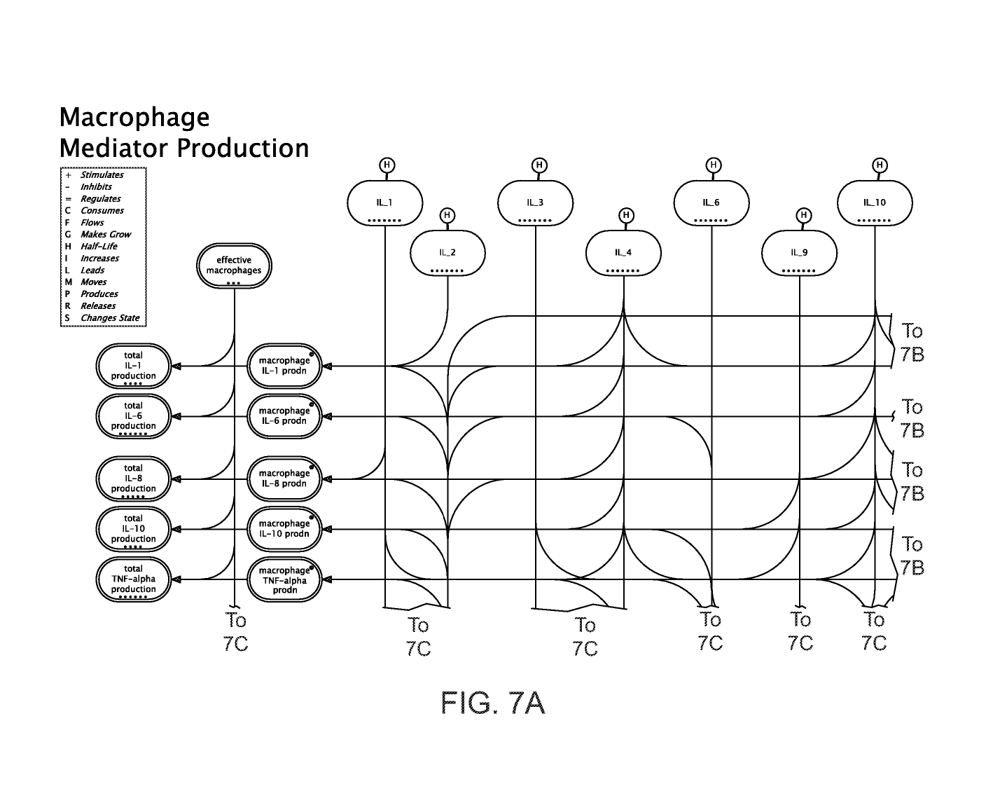

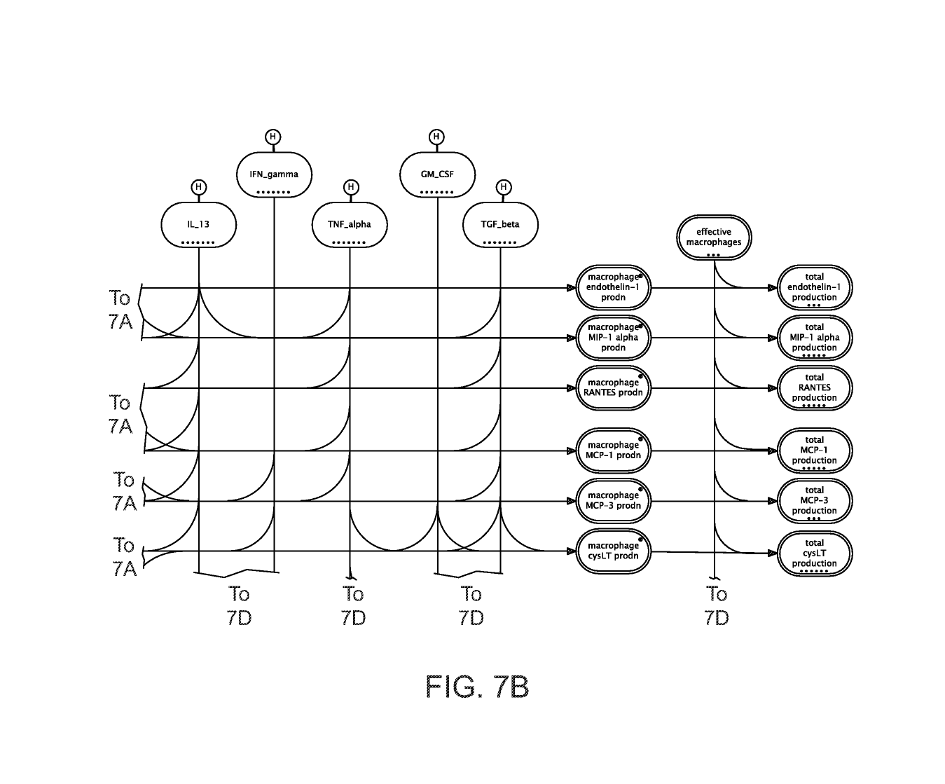

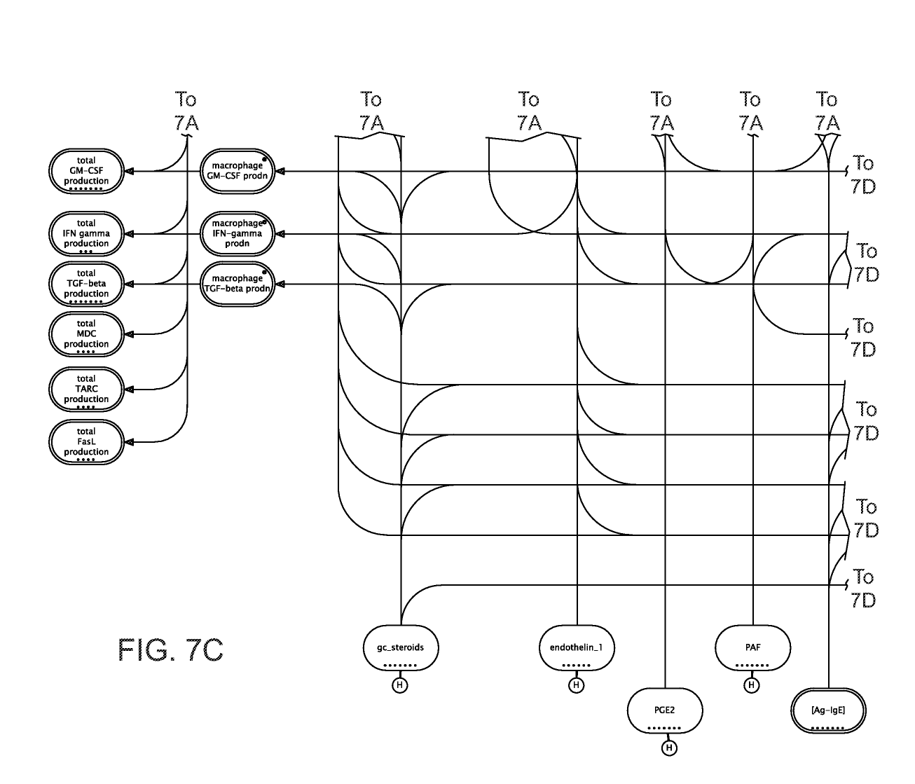

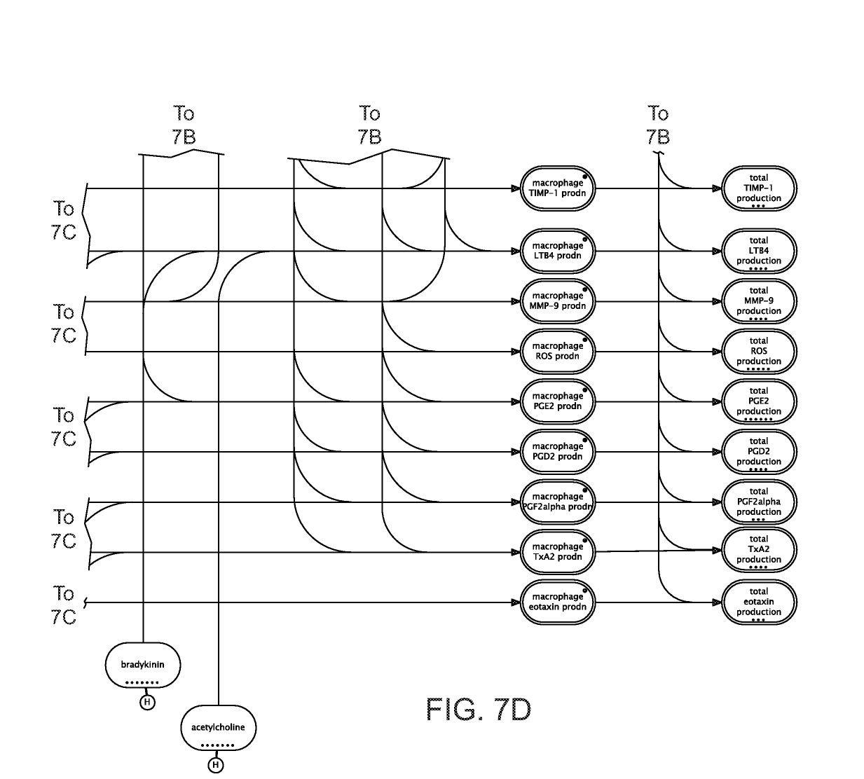

FIG. 6 illustrates macrophage population dynamics in an exemplary embodiment of the invention. The dynamics begin with monocyte hematopoiesis, which results in a population of circulating inactive monocytes. The circulating monocytes are recruited to the respiratory system, becoming tissue inactive macrophages. Within the respiratory system tissue, inactive macrophages may change state to active macrophages, and vice versa. Both active and inactive macrophages can become apoptosed, or can move to the luminal fluid and clear the respiratory system. Macrophage activation is regulated by one or more of IL-1, IFN-γ, TNF-α, GM-CSF, C5a, antigen-IgE interaction, IL-9, and IL-10. Macrophage apoptosis is regulated by various cytokines as well as by autocrine factors. Cytokines regulating apoptosis include MMP-9, ROS, glucocorticosteroids, and/or FasL. Autocrine apoptosis regulation is mediated by macrophage recruitment and macrophage activation. Macrophages contribute to the total production of one or more of IL-1, IL-6. IL-8, IL-10, TNF-α, GM-CSF, IFN-γ, TGF-β, MDC, TARC, FasL, endothelin-1, MIP-1α, RANTES, MCP-1, MCP-3, CysLT, TIMP-1, LTB4, MMP-9, ROS, PGE2, PGD2, PGF2α, TxA2 and eotaxin. The production of each of these mediators by macrophages is regulated by one or more of IL-1, IL-2, IL-3, IL-4, IL-6, IL-9, IL-10, IL-13, TNF-α, IFN-γ, TGF-β, GM-CSF, endothelin, PGE2, PAF, FcERII, bradykinin, acetylcholine and glucocorticosteroids, as described in FIG. 7.

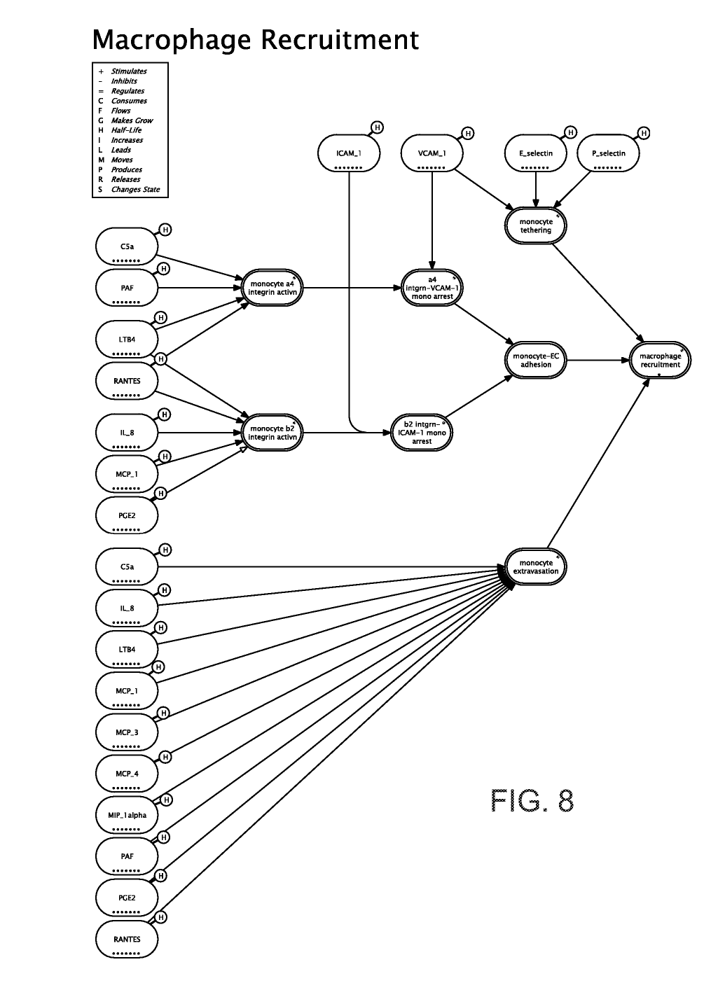

FIG. 8 illustrates macrophage recruitment as a function of monocyte tethering, monocyte extravasation, and monocyte-endothelial cell adhesion. Monocyte tethering is responsive to one or more of VCAM-1, E selectin, and P selectin. Monocyte extravasation is affected by C5a, IL-8, LTB4, MCP-1, MCP-3, MCP-4, MIP-1α, PAF, PGE2 and RANTES. Circulating monocytes express α4 integrin (identified as a4 integrin in the figures), which is activated by C5a, PAF, LTB4 and RANTES, and β2 integrin (identified as b2 integrin in the figures), which is activated by LTB4, RANTES, IL-8, MCP-1 and PGE4. Activation of α4 integrin in combination with VCAM-1 arrest (slow down) monocytes in circulation permitting adhesion to endothelial cells. Activation of β2 integrin, in combination with ICAM-1, also arrest monocytes, thus permitting adhesion of the monocytes to endothelial cells.

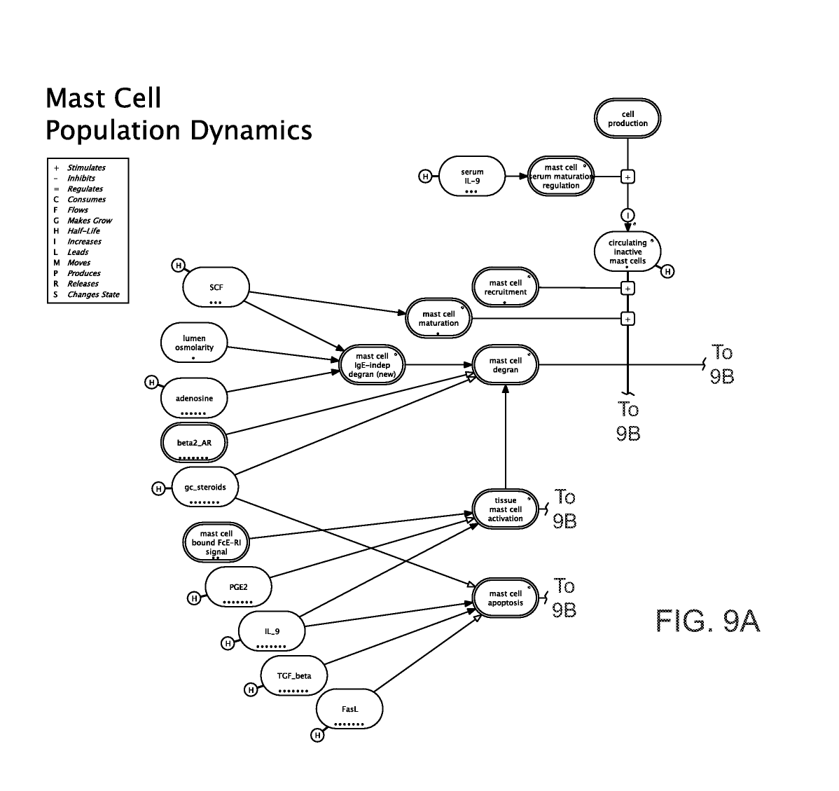

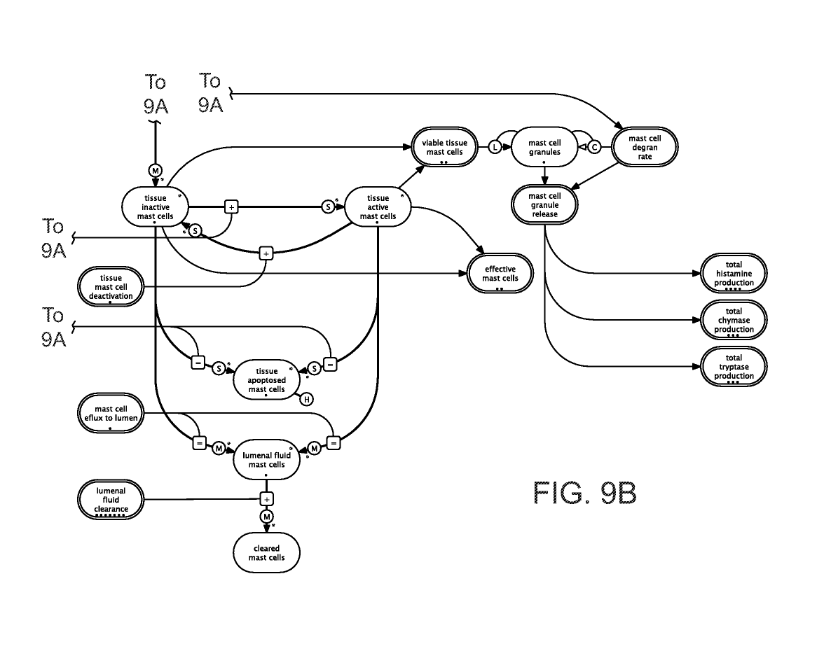

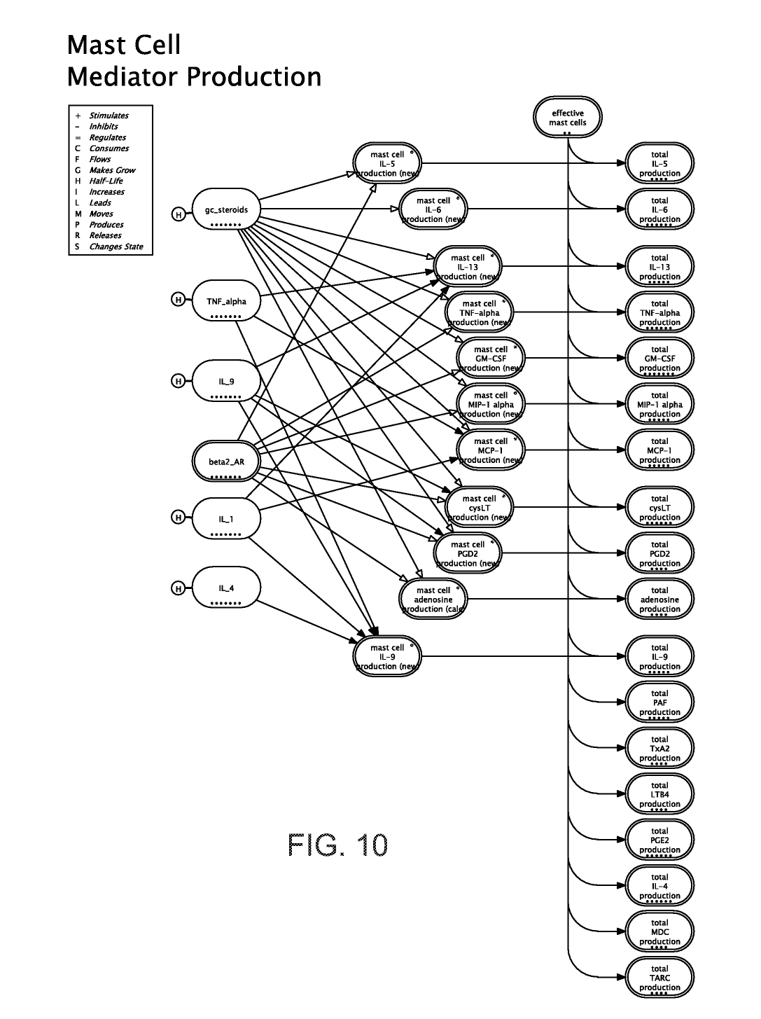

FIG. 9 illustrates mast cell population dynamics. The dynamics begin with cell production, which results in a population of circulating inactive mast cells. The circulating mast cells are recruited to the respiratory system, becoming tissue inactive mast cells. Within the respiratory system tissue, inactive mast cells may change state to active mast cells, and vice versa. Both active and inactive mast cells can become apoptosed, or can move to the luminal fluid and clear the respiratory system. Mast cell activation is regulated by one or more of PGE2, IL-9, and mast cell bound FcE-RI signal. Mast cell apoptosis is regulated by various cytokines as well as by autocrine factors. Cytokines regulating apoptosis include glucocorticosteroids and FasL. Autocrine apoptosis regulation is mediated by mast cell recruitment and activation. Mast cell degranulation is regulated by lumen osmolarity, adenosine, SCF, β₂-AR agonist and glucocorticosteroids. Degranulation, as represented by mast cell granule release, affects total histamine, chymase and tryptase production. Mast cells contribute to the total production of at least one of IL-5, IL-6, IL-13, TNF-α, GM-CSF, MIP-1a, MCP-1, CysLT, PGD2, adenosine, PAF and/or TxA2. In production of each of these mediators by mast cells is regulated by one or more of β₂-AR agonists, the desensitized fraction β₂-AR agonist receptor and glucocorticosteroids, as described in FIG. 10.

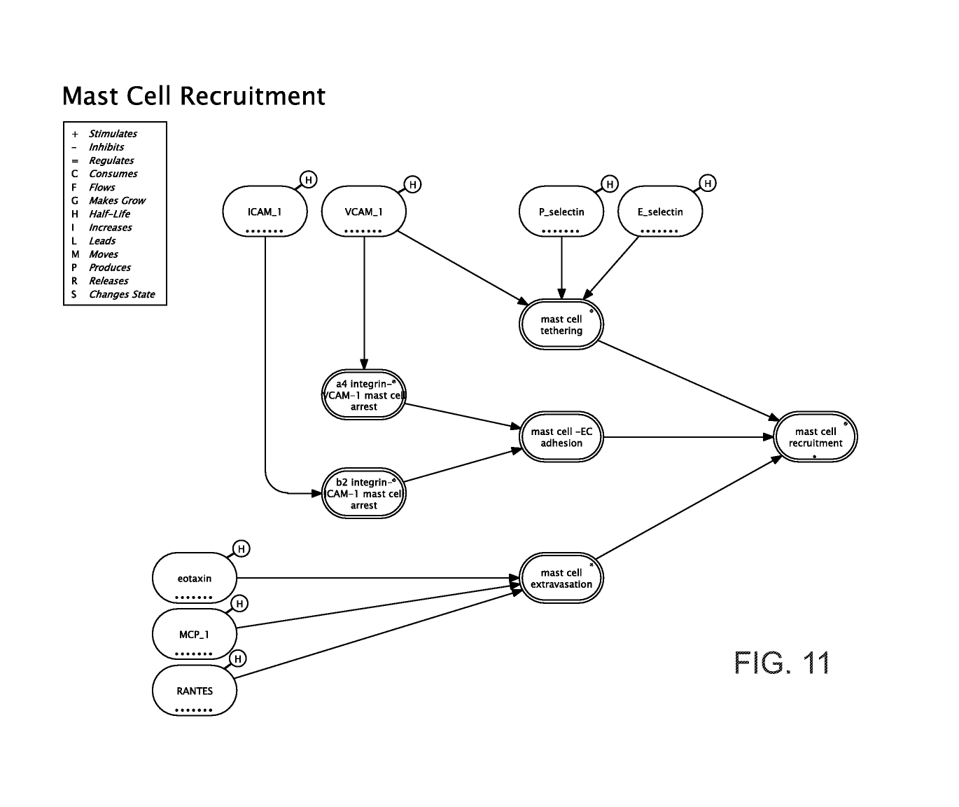

FIG. 11 illustrates mast cell recruitment as a function of mast cell tethering, mast cell extravasation, and mast cell-endothelial cell adhesion. Mast cell tethering is responsive to one or more of VCAM-1, E selectin, and P selectin. Mast cell extravasation is affected by eotaxin, MCP-1 and RANTES. Activation of α4 integrin in combination with VCAM-1 arrest mast cells in circulation permitting adhesion to endothelial cells. Activation of β2 integrin, in combination with ICAM-1, also arrest mast cells, thus permitting adhesion of the mast cells to endothelial cells.

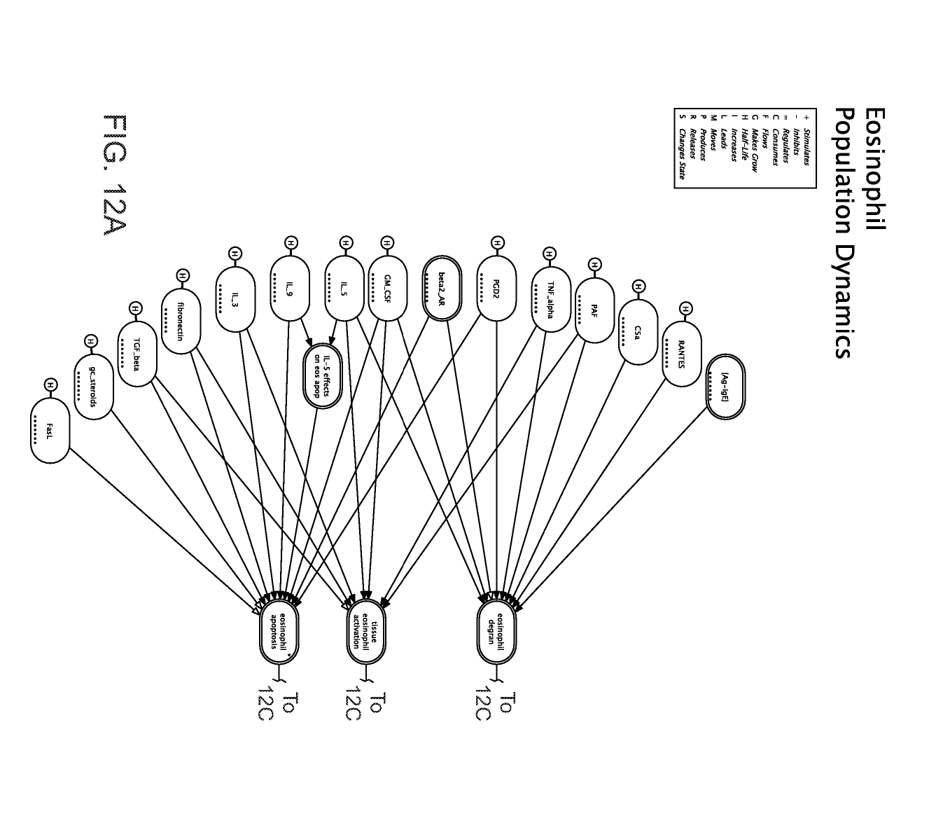

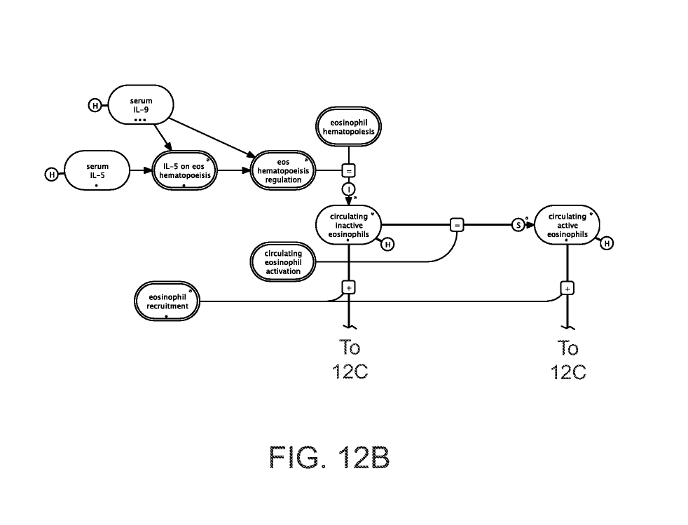

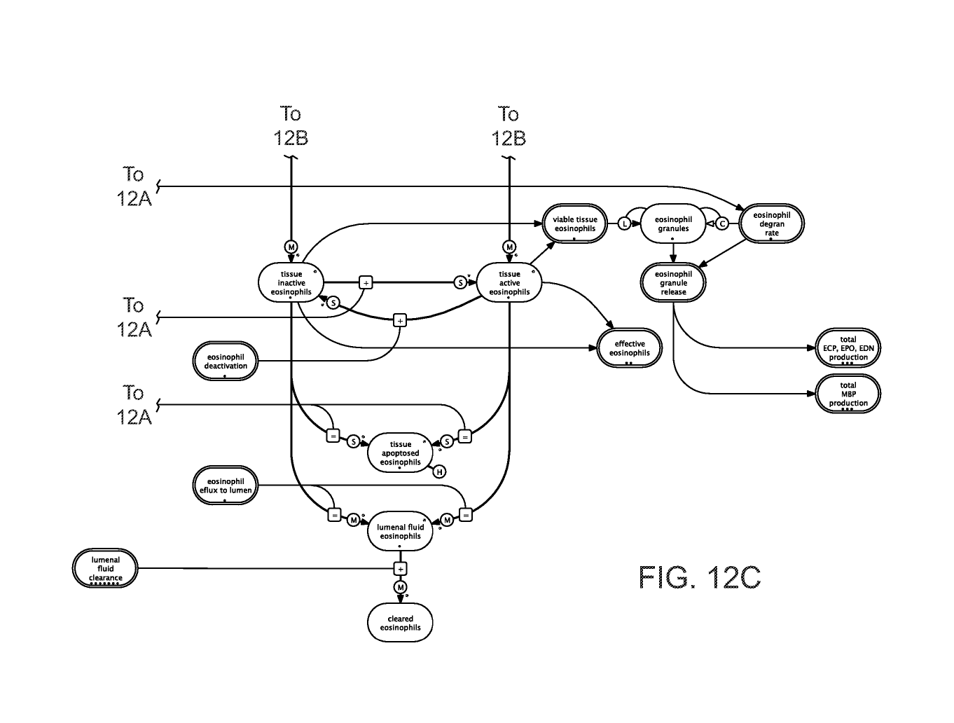

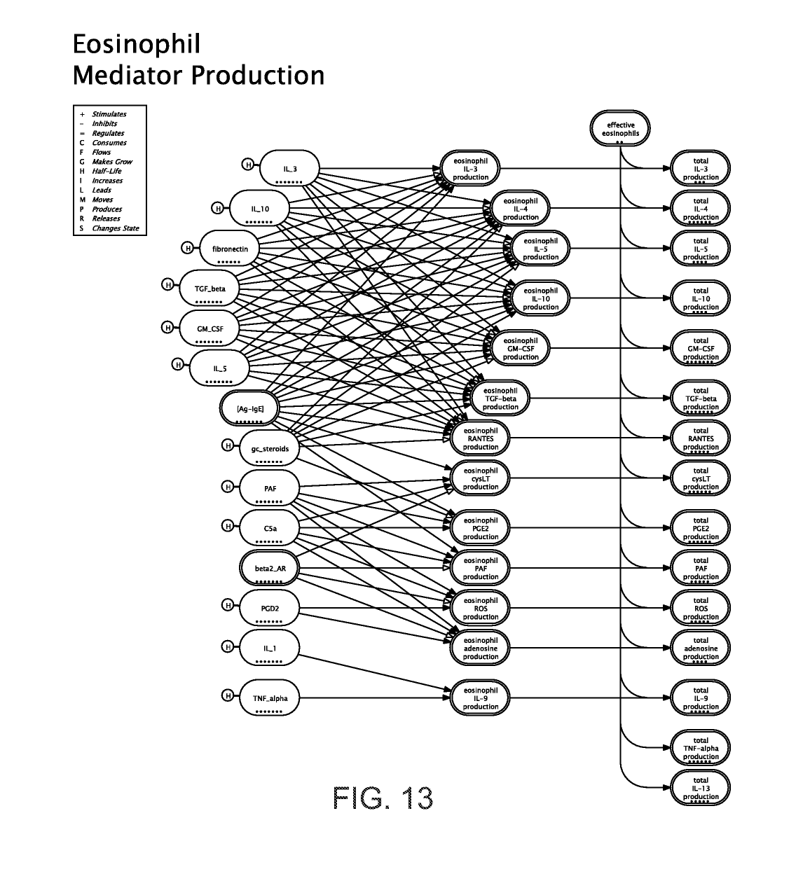

FIG. 12 illustrates eosinophil population dynamics. The dynamics begin with eosinophil hematopoiesis, and eos regulation thereof, which results in a population of circulating inactive eosinophils. The circulating eosinophils are recruited to the respiratory system, becoming tissue inactive eosinophils. Within the respiratory system tissue, inactive eosinophils may change state to active eosinophils, and vice versa. Both active and inactive eosinophils can become apoptosed, or can move to the luminal fluid and clear the respiratory system. Eosinophil activation is regulated by one or more of PAF, IL-5, TNF-α, GM-CSF, IL-9, IL-3, fibronectin, and TGF-β. Eosinophil apoptosis is regulated by various cytokines as well as by autocrine factors. Cytokines regulating apoptosis include at least one of PGD2, IL-5, GM-CSF, IL-3, fibronectin, TGF-β, β₂-AR agonist, glucocorticosteroid, and FasL. Eosinophil degranulation is regulated by one or more of RANTES, PGD2, PAF, C5a, IL-5, TNF-α, GM-CSF, β₂-AR agonist and antigen-IgE. Degranulation, as represented by eosinophil granule release, affects total ECP, EPO, EDN and/or MBP production. Eosinophils contribute to the total production of one or more of IL-3, IL-4, IL-5, IL-9, IL-10, IL-13, GM-CSF, TGF-β, TNF-α, RANTES, CysLT, PGE2, PAF, ROS and adenosine. The production of each of these mediators by eosinophils is regulated by one or more of IL-1, IL-10, IL-13, fibronectin, TGF-β, TNF-α, GM-CSF, IL-5, FcERII, glucocorticosteroids, PAF, C5a, PGD2, β₂-AR agonists and the desensitized fraction of β₂-AR agonist receptors, as described in FIG. 13.

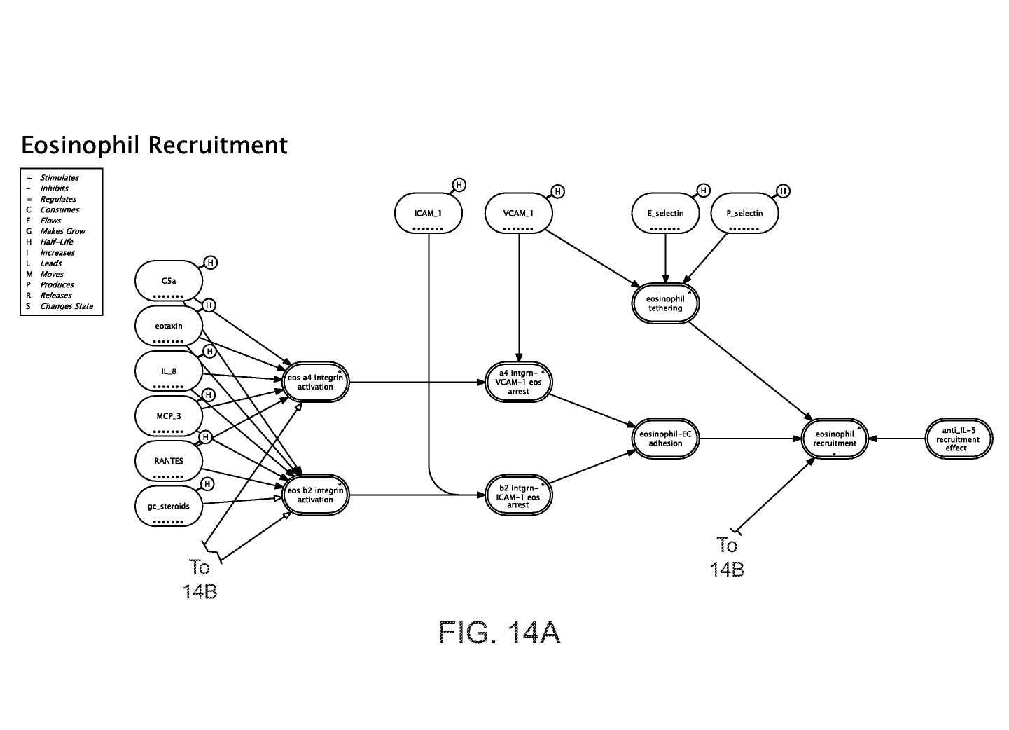

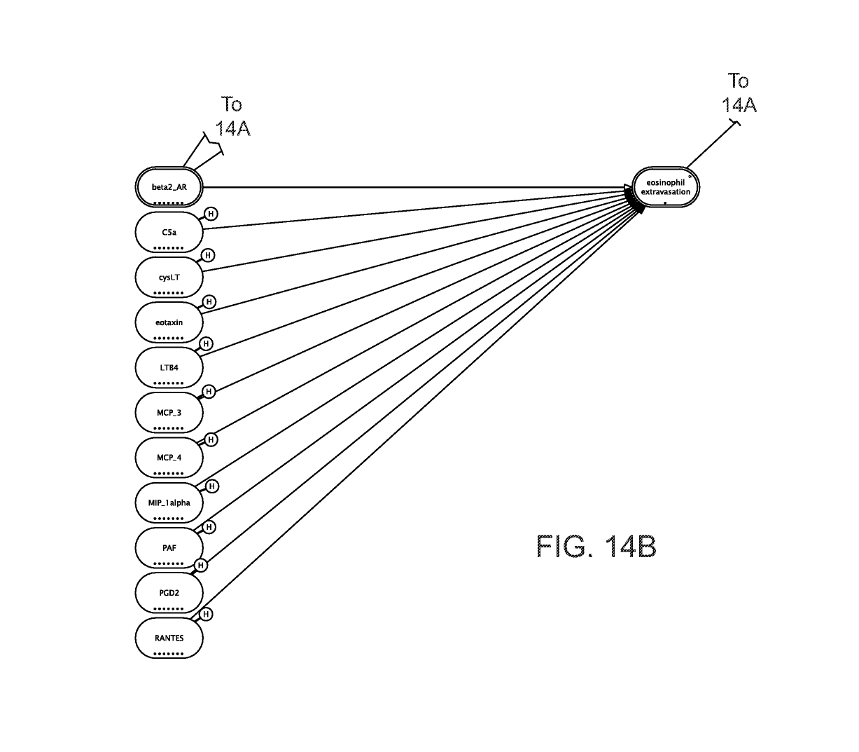

FIG. 14 illustrates eosinophil recruitment as a function of eosinophil tethering, eosinophil extravasation, and eosinophil-endothelial cell adhesion. Eosinophil tethering is responsive to one or more of VCAM-1, E selectin, and P selectin. Monocyte extravasation is affected by at least one of β₂-AR agonist, C5a, CysLT, eotaxin, LTB4, MCP-3, MCP-4, MIP-1α, PAF, PGD2, and RANTES. Circulating eosinophils express α4 integrin, which is activated by at least one of C5a, eotaxin, IL-8, MCP-3 and RANTES, and β2 integrin, which is activated by at least one of C5a, eotaxin, IL-8, MCP-3, RANTES, glucocorticoid steroids and β₂-AR agonist. Activation of α4 integrin in combination with VCAM-1 arrest eosinophils in circulation permitting adhesion to endothelial cells. Activation of β2 integrin, in combination with ICAM-1, also arrest eosinophils, thus permitting adhesion of the eosinophils to endothelial cells.

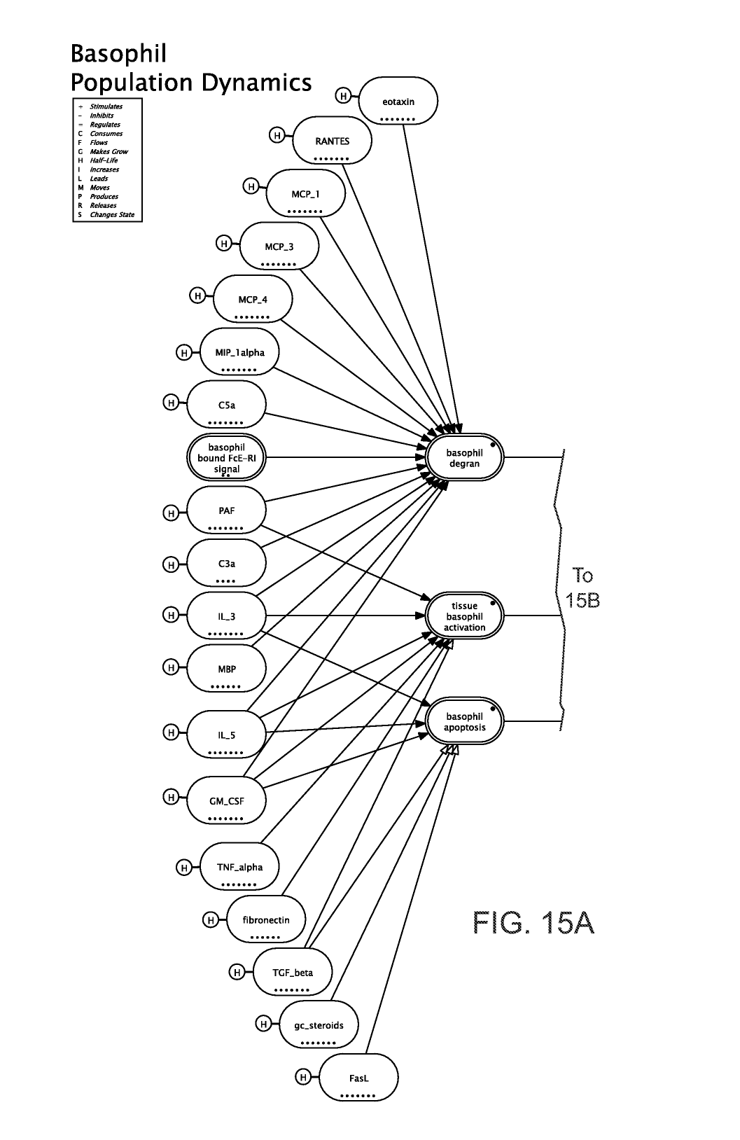

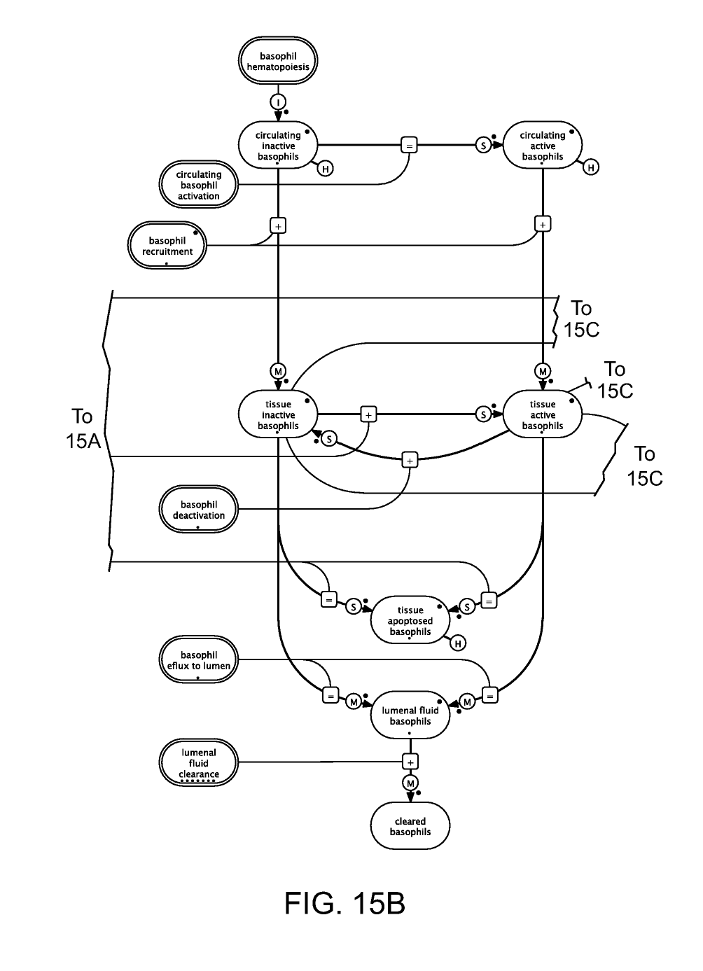

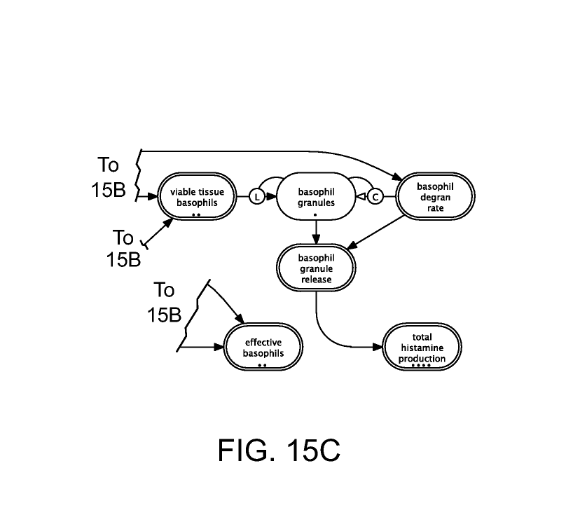

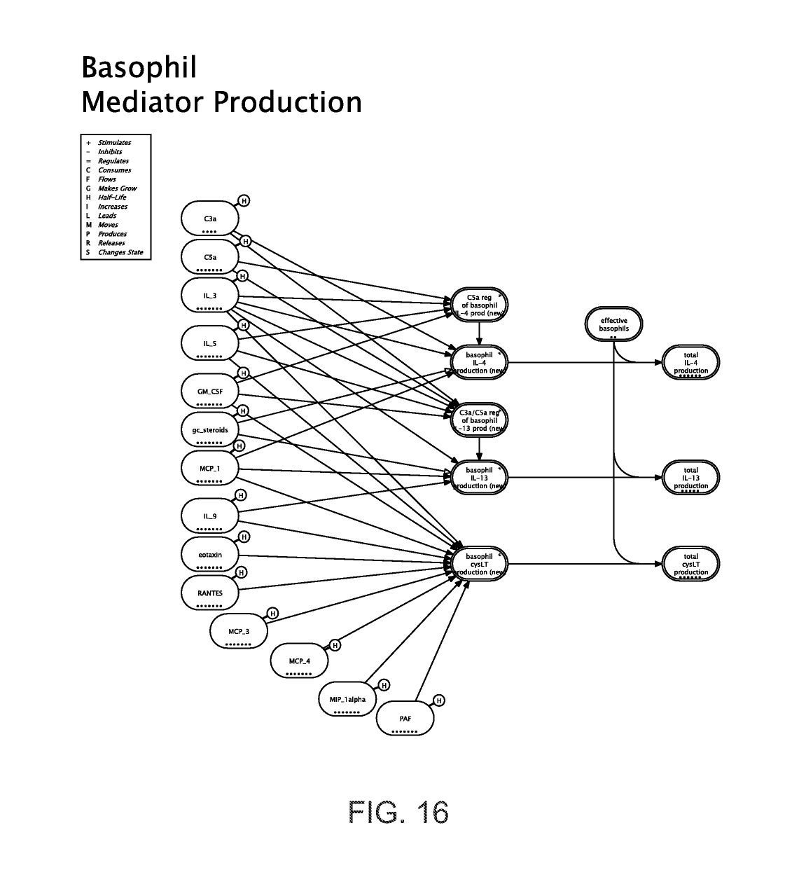

FIG. 15 illustrates basophil population dynamics. The dynamics begin with basophil hematopoiesis, which results in a population of circulating inactive basophils. The circulating basophils are recruited to the respiratory system, becoming tissue inactive basophils. Within the respiratory system tissue, inactive basophils may change state to active basophils, and vice versa. Both active and inactive basophils can become apoptosed, or can move to the luminal fluid and clear the respiratory system. Basophil activation is regulated by one or more of PAF, IL-3, IL-5, GM-CSF, basophil bound antigen-IgE, TNF-α, fibronectin and TGF-β. Basophil apoptosis is regulated by various cytokines as well as by autocrine factors. Cytokines regulating apoptosis include IL-3, IL-5, GM-CSF, TGF-β, glucocorticoid steroid, and/or FasL. Basophil degranulation is regulated by at least one of eotaxin, RANTES, MCP-1, MCP-3, MCP-4, MIP-1α, C5a, basophil bound FcE-RI, IL-3, PAF, C3a, MBP, IL-5, and GM-CSF. Degranulation, as represented by basophil granule release, affects total histamine production. Basophils contribute to the total production of one or more of IL-4, IL-13, and CysLT. The production of each of these mediators is regulated by one or more of C3a, C5a, IL-3, IL-5, IL-9, GM-CSF, glucocorticosteroid, MCP-1, eotaxin, RANTES, MCP-3, MCP-4, MIP-1a and PAF, as described in FIG. 16.

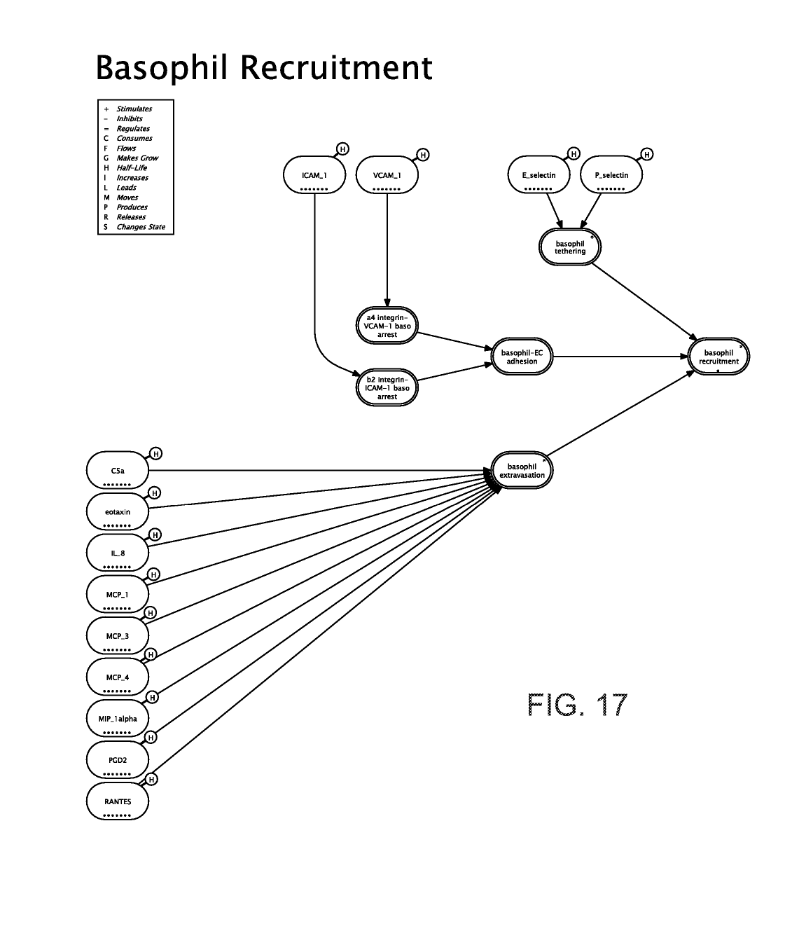

FIG. 17 illustrates basophil recruitment as a function of basophil tethering, basophil extravasation, and basophil-endothelial cell adhesion. Basophil tethering is responsive to E selectin and/or P selectin. Basophil extravasation is affected by at least one of C5a, eotaxin, IL-8, MCP-1, MCP-3, MCP-4, MIP-1α, PGD2 and RANTES. Activation of α4 integrin in combination with VCAM-1 arrest basophils in circulation permitting adhesion to endothelial cells. Activation of β2 integrin, in combination with ICAM-1, also arrest basophils, thus permitting adhesion of the basophils to endothelial cells.

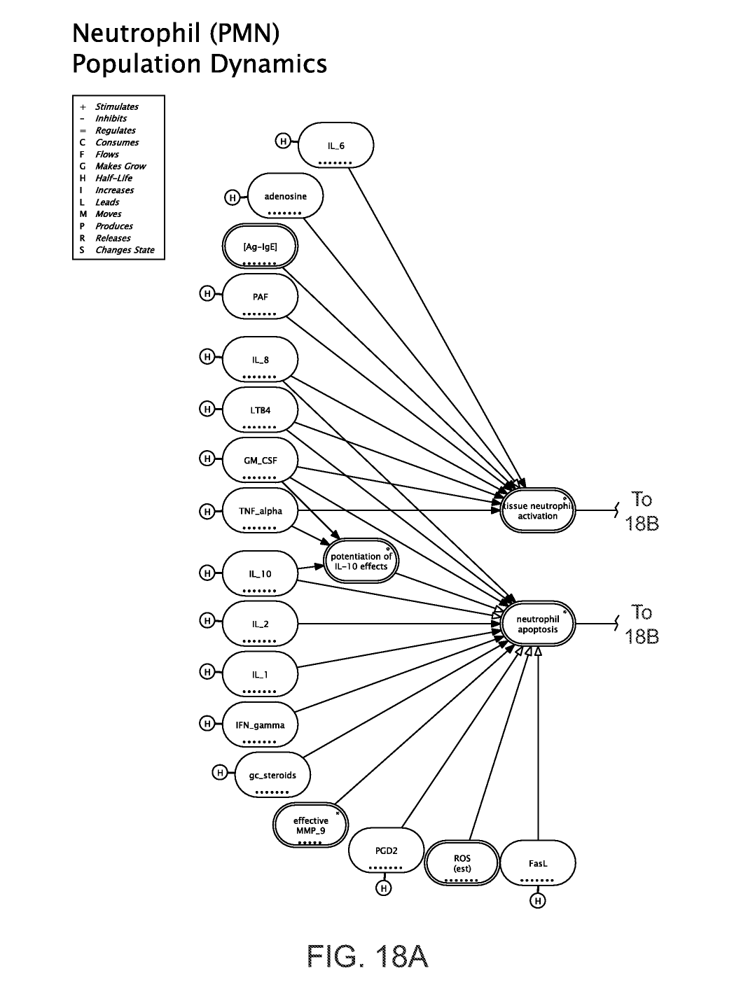

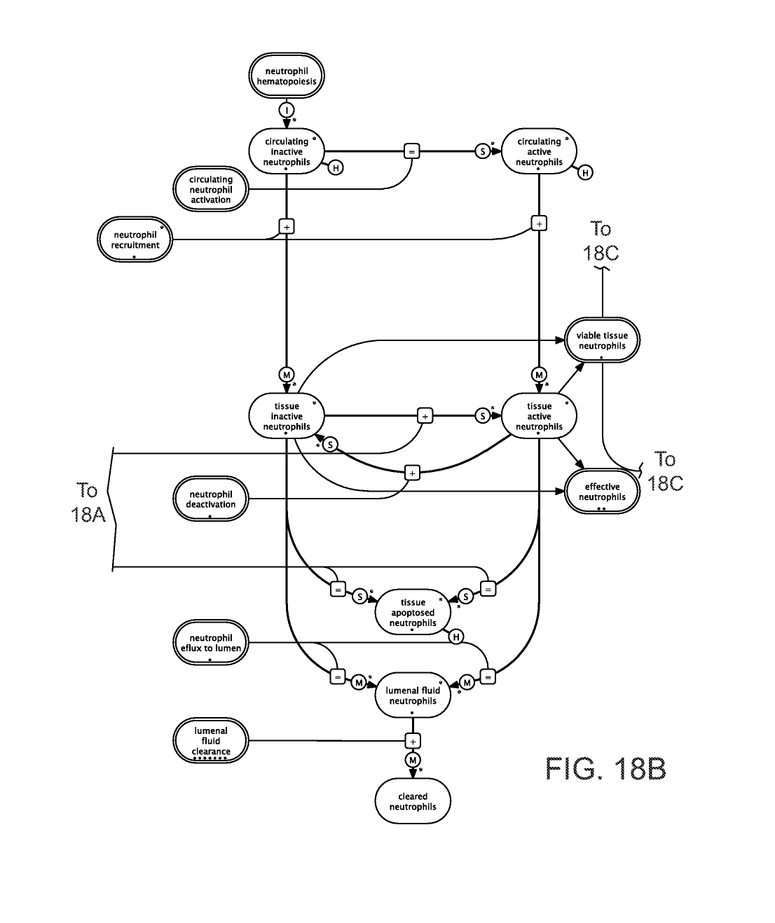

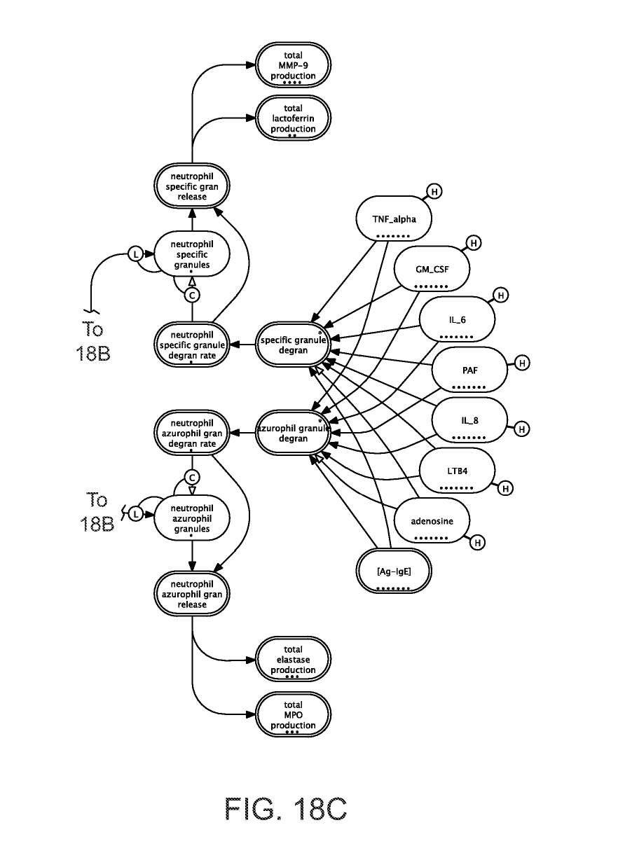

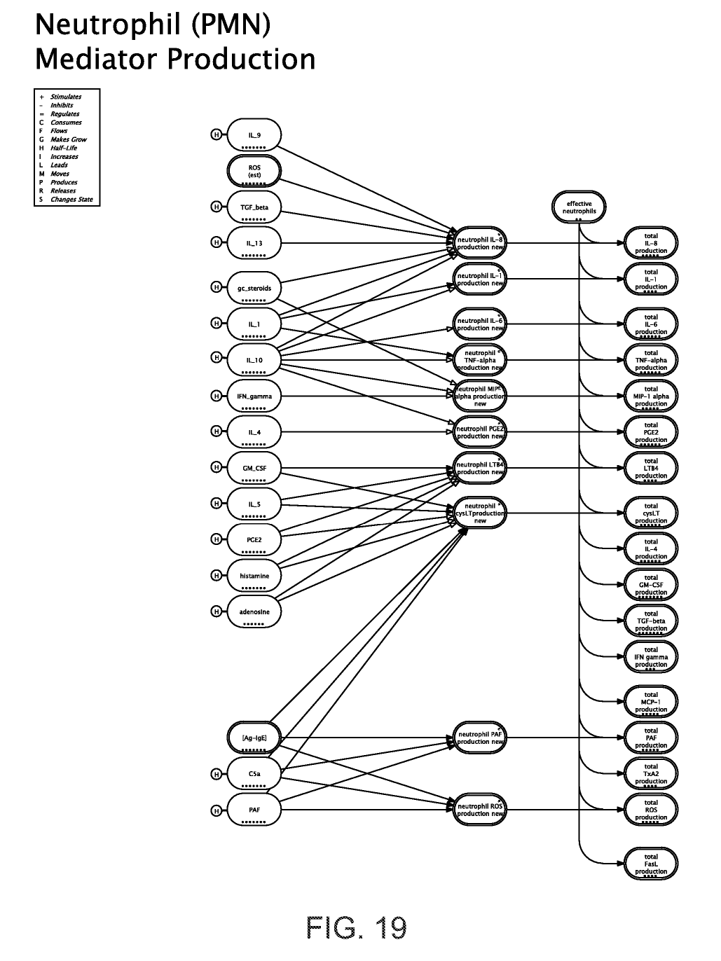

FIG. 18 illustrates neutrophil population dynamics. The dynamics begin with neutrophil hematopoiesis, which results in a population of circulating inactive neutrophils, which in turn may change state to become active circulating neutrophils. Within the respiratory system tissue, inactive neutrophils may change state to active neutrophils, and vice versa. Both active and inactive neutrophils can become apoptosed, or can move to the luminal fluid and clear the respiratory system. Neutrophil activation is regulated by at least one of TNF-α, GM-CSF, IL-6, PAF, IL-8, LTB4, adenosine, and antigen-IgE. Neutrophil apoptosis is regulated by various cytokines as well as by autocrine factors. Cytokines regulating apoptosis include one or more of IL-10, GM-CSF, IL-8, LTB4, IL-1, IL-2, IFN-γ, glucocorticosteroid, MMP-9, PGD2, ROS and FasL. Neutrophil azurophil degranulation is regulated by at least one of TNF-α, GM-CSF, IL-6, PAF, IL-8, LTB4, adenosine and FcERII binding. Degranulation, as represented by neutrophil azurophil granule release, affects total MMP-9, lactoferrin, elastase and/or MPO production. Neutrophils contribute to the total production of at least one of IL-8, IL-1, IL-6, TNF-α, MIP-1a, PGE2, LTB4, CysLT, IL-4, GM-CSF, TGF-β, IFN-γ, MCP-1, PAF, TxA2, ROS and FasL. The production of each of these mediators by neutrophils is regulated by one or more of ROS, TGF-β, IL-9, IL-13, glucocorticosteroid, IL-1, IL-10, IFN-γ, IL-4, GM-CSF, IL-5, PGE2, histamine, adenosine, antigen-IgE, C5a and PAF, as described in FIG. 19.

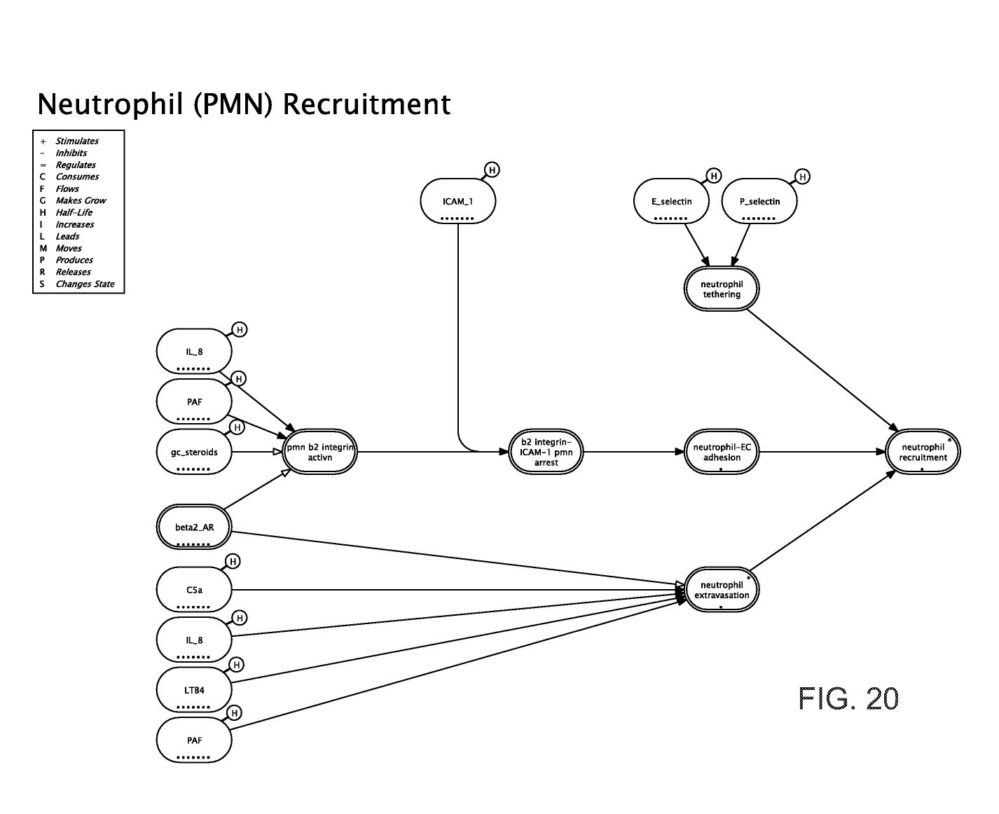

FIG. 20 illustrates neutrophil recruitment as a function of neutrophil tethering, neutrophil extravasation, and neutrophil-endothelial cell adhesion. Neutrophil tethering is responsive to E selectin and/or P selectin. Neutrophil extravasation is affected by at least one of β₂-AR agonist, C5a, IL-8, LTB4 and PAF. Circulating neutrophils express β2 integrin, which is activated by IL-8, PAF, glucocorticoid steroids and/or β₂-AR agonist. Activation of β2 integrin, in combination with ICAM-1, also arrest neutrophils, thus permitting adhesion of the neutrophils to endothelial cells.

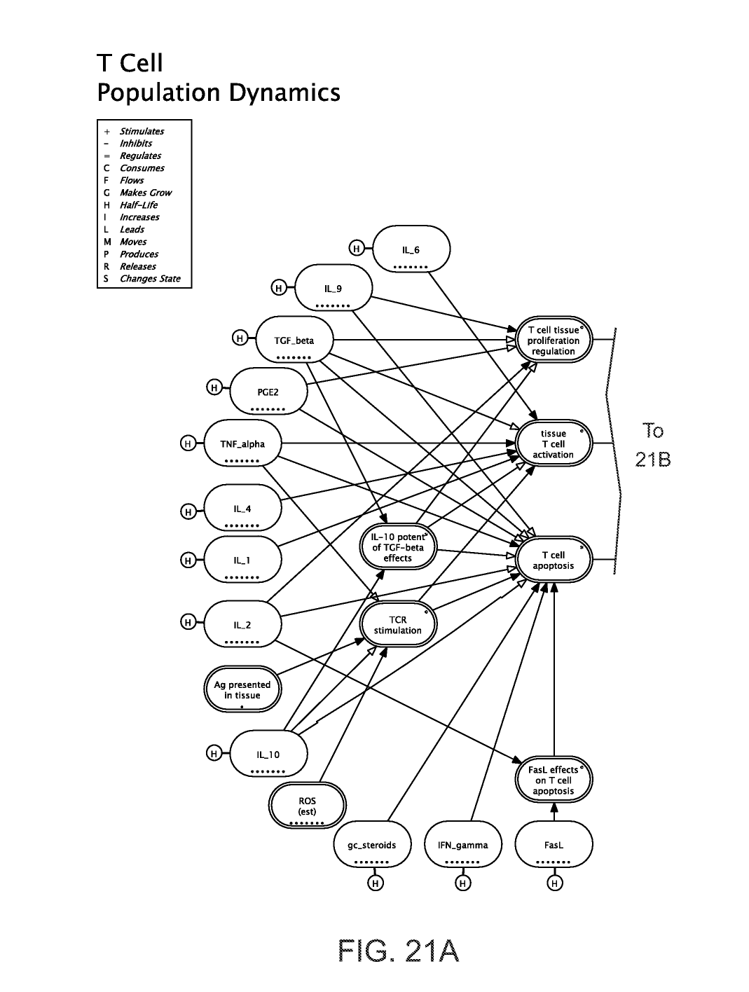

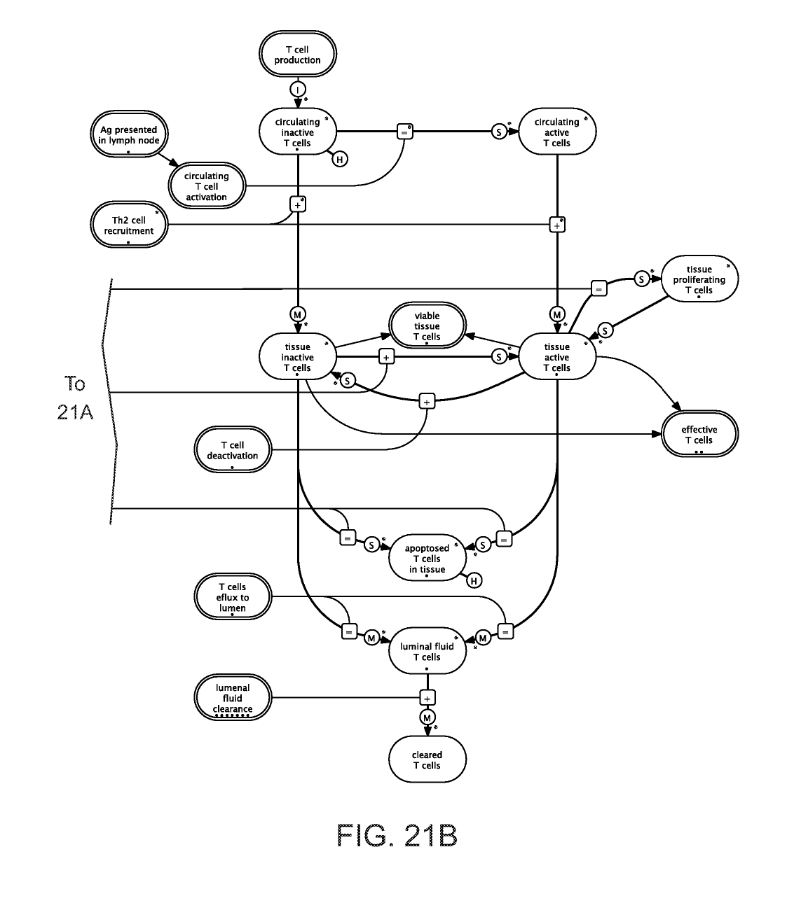

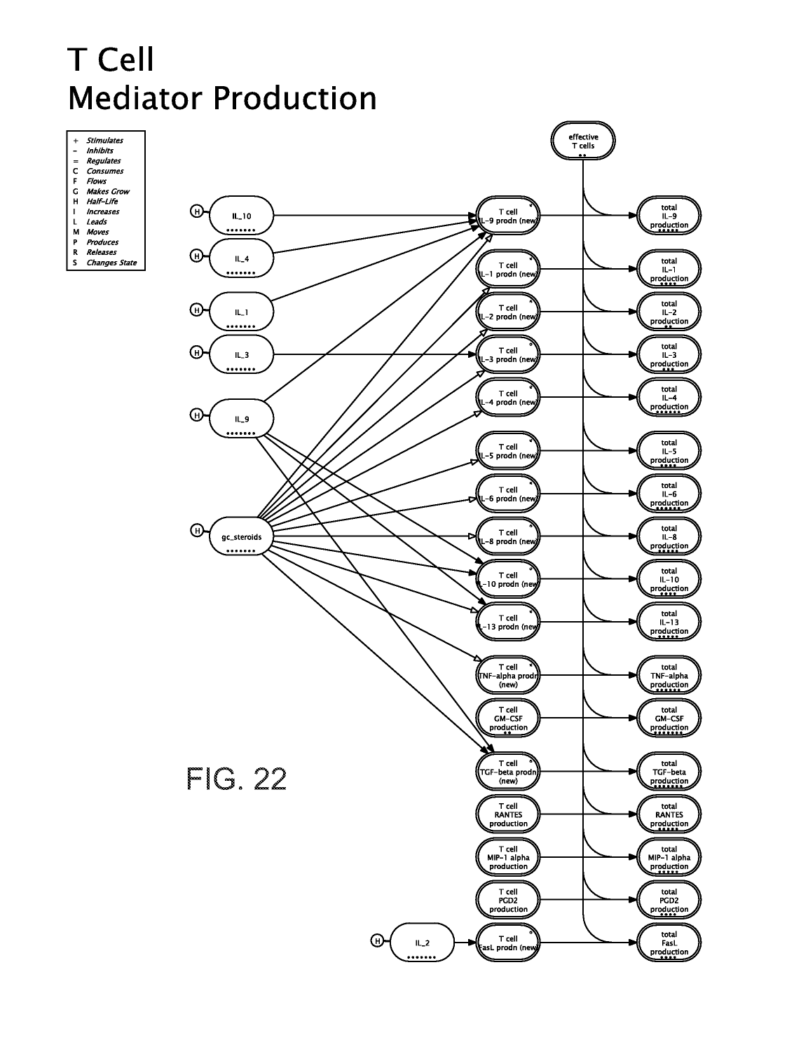

FIG. 21 illustrates T cell population dynamics in an exemplary embodiment of the invention. The dynamics begin with T cell production, which results in a population of circulating inactive T cells. The circulating T cells are recruited to the respiratory system, becoming tissue inactive T cells. Activated T cells, previously exposed to antigen in lymph nodes, can be recruited to respiratory tissue. Within the respiratory system tissue, inactive T cells may change state to active T cells, and vice versa. Active T cells can become proliferating T cells. Both active and inactive T cells can become apoptosed, or can move to the luminal fluid and clear the respiratory system. T cell recruitment is affected by one or more of ICAM-1, VCAM-1, e-selectin, eotaxin, RANTES, MCP-1, MIP-1a, PGD2 and PGE2. T cell activation is regulated by at least one of IL-6, IL-4, IL-10, TNF-α, IL-1 and TCR stimulation by antigen, ROS, IL-1 or TNF-α. T cell apoptosis is regulated by various cytokines as well as by autocrine factors. Cytokines regulating apoptosis include one or more of PGE2, IL-10, TCR stimulation, IL-10, TNF-α, IL-2, glucocorticosteroids, IFN-γ, and FasL. Autocrine apoptosis regulation is mediated by T cell recruitment and T cell activation. T cells contribute to the total production of at least one of IL-1, IL-2, IL-4, IL-5, IL-6, IL-8, IL-10, IL-13, TNF-α, GM-CSF, TGF-β, RANTES, MIP-1a, PGD2, and FasL, as described in FIG. 22. Production of these mediators by T cells is regulated by one or more of IL-1, IL-2, IL-3, IL-4, IL-9, IL-10, and glucocorticoid steroids.

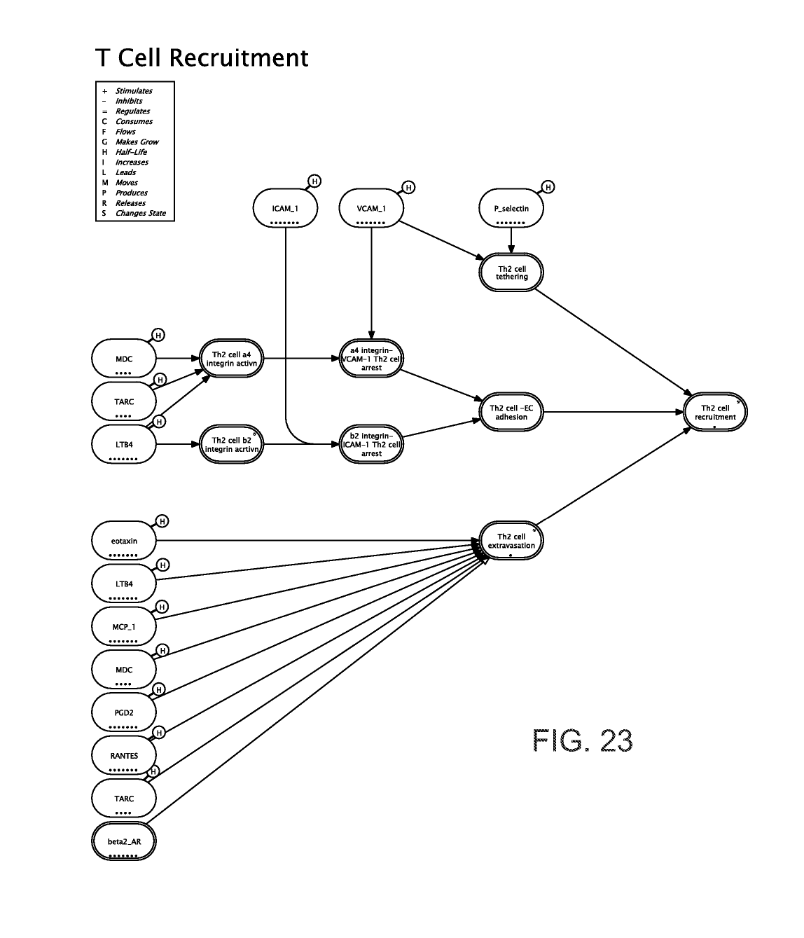

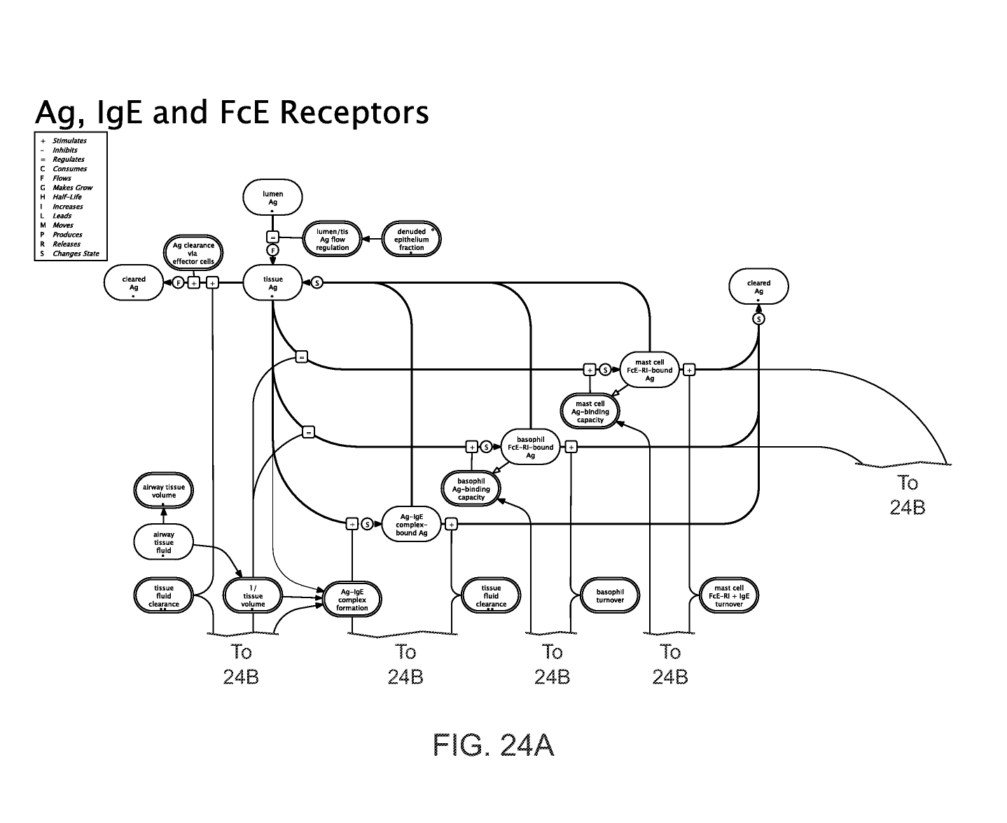

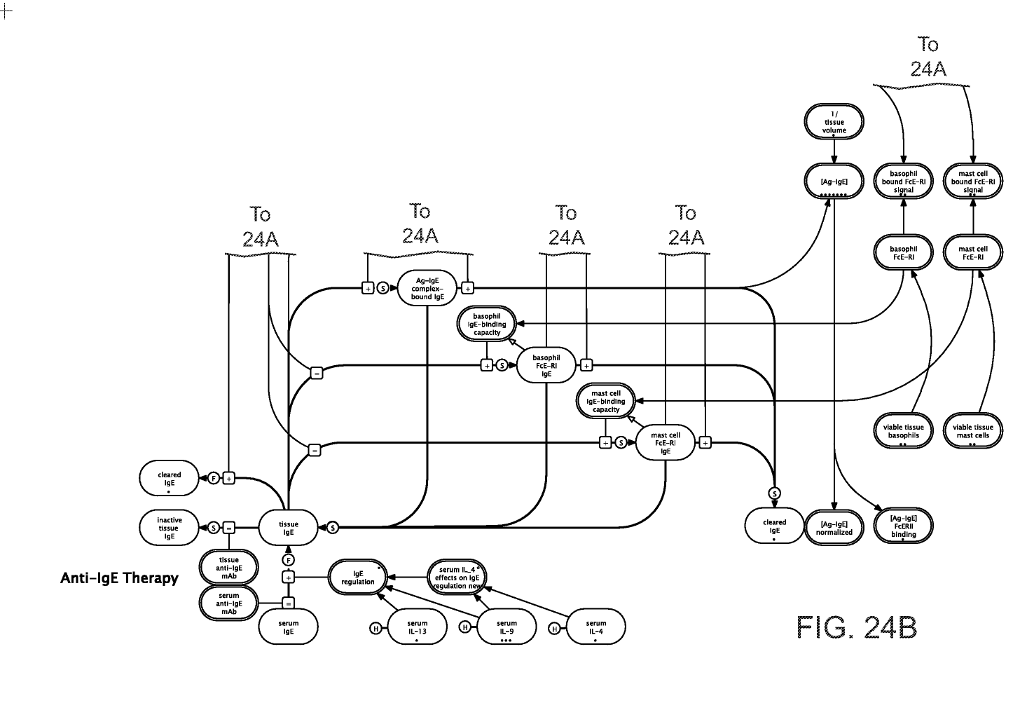

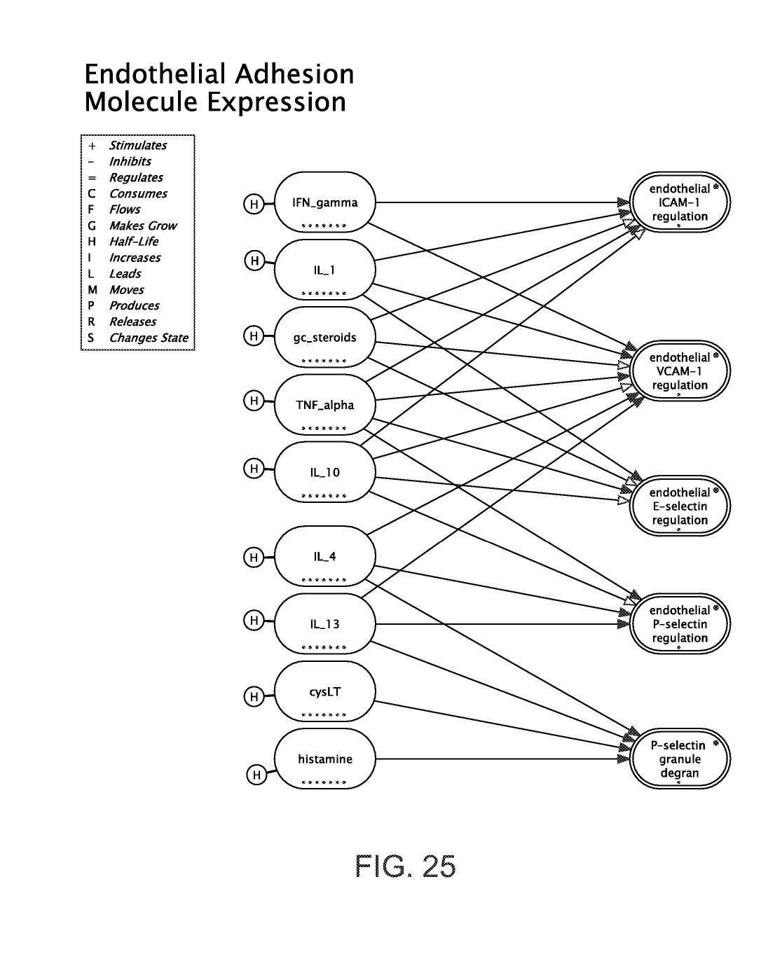

FIG. 23 illustrates T cell recruitment as a function of T cell tethering, T cell extravasation, and T cell-endothelial cell adhesion. T cell tethering is responsive to one or more of VCAM-1, E selectin, and P selectin. T cell extravasation is affected by one or more of eotaxin, LTB4, MCP-3, MDC, PGD2, RANTES, TARC and β₂-AR agonist. Circulating T cells express α4 integrin, which is activated by MDC, TARC and/or LTB4 and β2 integrin, which is activated by LTB4. Activation of α4 integrin in combination with VCAM-1 arrest T cells in circulation permitting adhesion to endothelial cells. Activation of α4 integrin in combination with VCAM-1 arrest T cells in circulation permitting adhesion to endothelial cells. Activation of β2 integrin, in combination with ICAM-1, also arrest T cells, thus permitting adhesion of the T cells to endothelial cells.

This invention can include a single computer model that serves a number of purposes. Alternatively, this invention can include a set of large-scale computer models covering a broad range of physiological systems. In addition to including a model of the a respiratory system, the system can include complementary computer models, such as, for example, epidemiological computer models and pathogen computer models. For use in healthcare, computer models can be designed to analyze a large number of subjects and therapies. In some instances, the computer models can be used to create a large number of validated virtual patients and to simulate their responses to a large number of therapies.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

E. Methods of Simulating Mammalian Respiratory Systems

The invention also provides methods of simulating a respiratory system of a mammal, said method comprises executing a computer model of a respiratory system as described above. Methods of simulating a respiratory system can further comprise applying a virtual protocol to the computer model to generate a set of outputs represent a phenotype of the biological system. The phenotype can represent a normal state or a diseased state. In certain implementations, the methods can further include accepting user input specifying one or more parameters or variables associated with one or more mathematical representations prior to executing the computer model. Preferably, the user input comprises a definition of a virtual patient or a definition of the virtual protocol.

Running the computer model produces a set of outputs for a biological system represented by the computer model. The set of outputs represent one or more phenotypes of the biological system, i.e., the simulated subject, and includes values or other indicia associated with variables and parameters at a particular time and for a particular execution scenario. For example, a phenotype is represented by values at a particular time. The behavior of the variables is simulated by, for example, numerical or analytical integration of one or more mathematical relations to produce values for the variables at various times and hence the evolution of the phenotype over time.

The computer executable software code numerically solves the mathematical equations of the model(s) under various simulated experimental conditions. Furthermore, the computer executable software code can facilitate visualization and manipulation of the model equations and their associated parameters to simulate different patients subject to a variety of stimuli. See, e.g., U.S. Pat. No. 6,078,739, entitled “Managing objects and parameter values associated with the objects within a simulation model.” Thus, the computer model(s) can be used to rapidly test hypotheses and investigate potential drug targets or therapeutic strategies.

In one implementation, the computer model can represent a normal state as well as an abnormal (e.g., a diseased or toxic) state of a biological system. For example, the computer model includes parameters that are altered to simulate an abnormal state or a progression towards the abnormal state. The parameter changes to represent a disease state are typically modifications of the underlying biological processes involved in a disease state, for example, to represent the genetic or environmental effects of the disease on the underlying physiology. By selecting and altering one or more parameters, a user modifies a normal state and induces a disease state of interest. In one implementation, selecting or altering one or more parameters is performed automatically. Exemplary respiratory diseases include asthma, chronic bronchitis, chronic obstructive pulmonary disease, emphysema, cystic fibrosis, respiratory failure, pulmonary edema, pulmonary embolism, pulmonary hypertension, pneumonia, tuberculosis (TB), and lung cancer.

In the present embodiment of the invention, various mathematical relations of the computer model, along with a modification defined by the virtual stimulus, can be solved numerically by a computer using standard algorithms to produce values of variables at one or more times based on the modification. Such values of the variables can, in turn, be used to produce the first set of results of the first set of virtual measurements.

One or more virtual patients in conjunction with the computer model can be created based on an initial virtual patient that is associated with initial parameter values. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model. For certain applications, the initial virtual patient itself can be created based on another virtual patient (e.g., a different initial virtual patient) in a manner as discussed above.

Alternatively, or in conjunction, one or more virtual patients in the computer model can be created based on an initial virtual patient using linked simulation operations as, for example, disclosed in the following publication: “Method and Apparatus for Conducting Linked Simulation Operations Utilizing A Computer-Based System Model”, (U.S. Application Publication No. 20010032068, published on Oct. 18, 2001). This publication discloses a method for performing additional simulation operations based on an initial simulation operation where, for example, a modification to the initial simulation operation at one or more times is introduced. In the present embodiment of the invention, such additional simulation operations can be used to create additional virtual patients in the computer model based on an initial virtual patient that is created using the initial simulation operation. In particular, a virtual patient can be customized to represent a particular subject. If desired, one or more simulation operations may be performed for a time sufficient to create one or more “stable” virtual patient of the computer model. Typically, a “stable” virtual patient is characterized by one or more variables under or substantially approaching equilibrium or steady-state condition.

Various virtual patients of the computer model can represent variations of the biological system that are sufficiently different to evaluate the effect of such variations on how the biological system responds to a given therapy. In particular, one or more biological processes represented by the computer model can be identified as playing a role in modulating biological response to the therapy, and various virtual patients can be defined to represent different modifications of the one or more biological processes. The identification of the one or more biological processes can be based on, for example, experimental or clinical data, scientific literature, results of a computer model, or a combination of them. Once the one or more biological processes at issue have been identified, various virtual patients can be created by defining different modifications to one or more mathematical relations included in the computer model, which one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model may be run based on a particular modification for a time sufficient to create a “stable” configuration of the computer model.

In certain implementations, the model of the respiratory system is executed while applying a virtual stimulus or protocol representing, e.g., exposure to an allergen or administration of a drug. A virtual stimulus can be associated with a stimulus or perturbation that can be applied to a biological system. Different virtual stimuli can be associated with stimuli that differ in some manner from one another. Stimuli that can be applied to a biological system can include, for example, existing or hypothesized therapeutic agents, treatment regimens, and medical tests. Additional examples of stimuli include exposure to existing or hypothesized disease precursors. Further examples of stimuli include environmental changes such as those relating to changes in level of exposure to an environmental agent (e.g., an antigen), and changes in level of physical activity or exercise.

A virtual protocol, e.g., a virtual therapy, representing an actual therapy can be applied to a virtual patient in an attempt to predict how a real-world equivalent of the virtual patient would respond to the therapy. Virtual protocols that can be applied to a biological system can include, for example, existing or hypothesized therapeutic agents and treatment regimens, mere passage of time, exposure to environmental toxins, increased exercise and the like. By applying a virtual protocol to a virtual patient, a set of results of the virtual protocol can be produced, which can be indicative of various effects of a therapy.

For certain applications, a virtual protocol can be created, for example, by defining a modification to one or more mathematical relations included in a model, which one or more mathematical relations can represent one or more biological processes affected by a condition or effect associated with the virtual protocol. A virtual protocol can define a modification that is to be introduced statically, dynamically, or a combination thereof, depending on the particular conditions and/or effects associated with the virtual protocol.

In certain implementations of the invention, the computer model is capable of simulating a therapy or action of a therapeutic agent selected from the group consisting of long-acting β₂-agonists (such as albuterol sulfate or formoterol), short-acting β₂-agonists (such as albuterol, bitoiterol, pirbuterol, terbutaline, or levalbuterol), combination therapies (such as ipratropium bromide+albuterol (Combivent®) or flucticasone+salmeterol (Advair®)), methylxanthines (such as theophylline), inhaled corticosteroids (such as beclomethasone, budesonide, flunisolide, fluticasone, or triamcinolone), oral corticosteroids (such as dexamethasone, prednisolone, hydrocortisone, methylprednisolone, prednisone), mast cell stabilizers (such as cromolyn sodium or nedocromil sodium), leukotriene modifiers (such as zafirlukast, zileuton, or montelukast), anticholinergics (such as ipratropium bromide), bronchodialators, anti-inflammatories, anti-TNF-α therapy, antibiotics, IL-13 antagonists, histamine receptor antagonists, anti-PAF, anti-IL-5, anti-IgE and immune system modifiers (such as omalizumab).

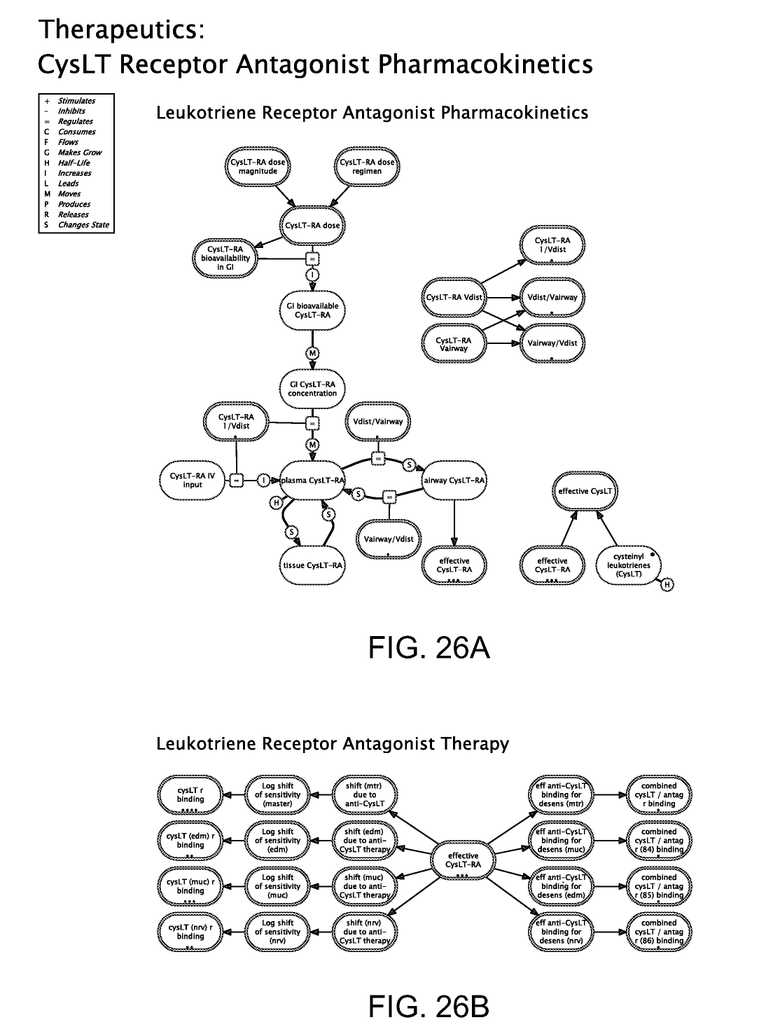

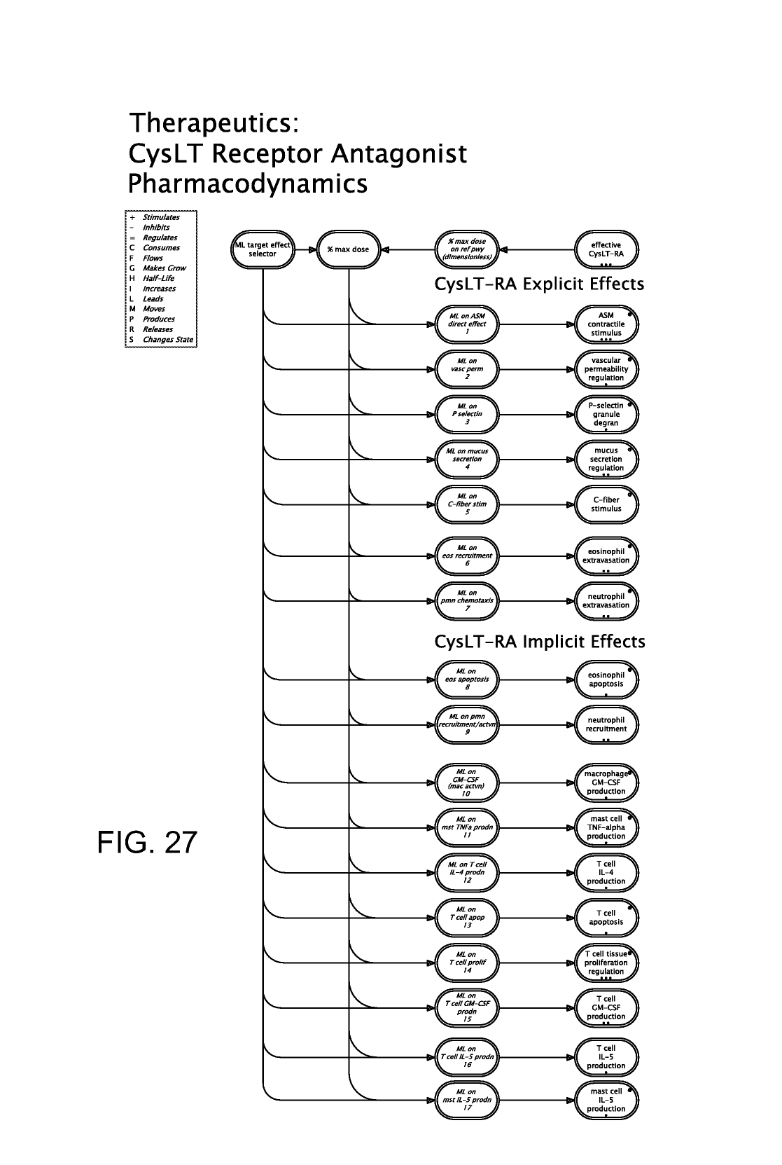

In one implementation, CysLT receptor antagonist therapy is simulated as described in FIG. 26. CysLT receptor antagonists will result in decreased CysLT receptor binding, particularly in edema causing cells, mucus secreting cells, nerve cells. The extent of decreased CysLT receptor binding will be regulated by effective binding of the receptor by the CysLT receptor antagonist and by the ratio of binding of CysLT to binding of the receptor antagonist. The simulation of the therapy can also take into consideration the pharmacokinetics of the therapeutic agent, as illustrated for CysLT receptor antagonists in FIG. 26. Similarly, the model can simulate the pharmacodynamics of the therapeutic agent, as illustrated for CysLT receptor antagonists in FIG. 27.

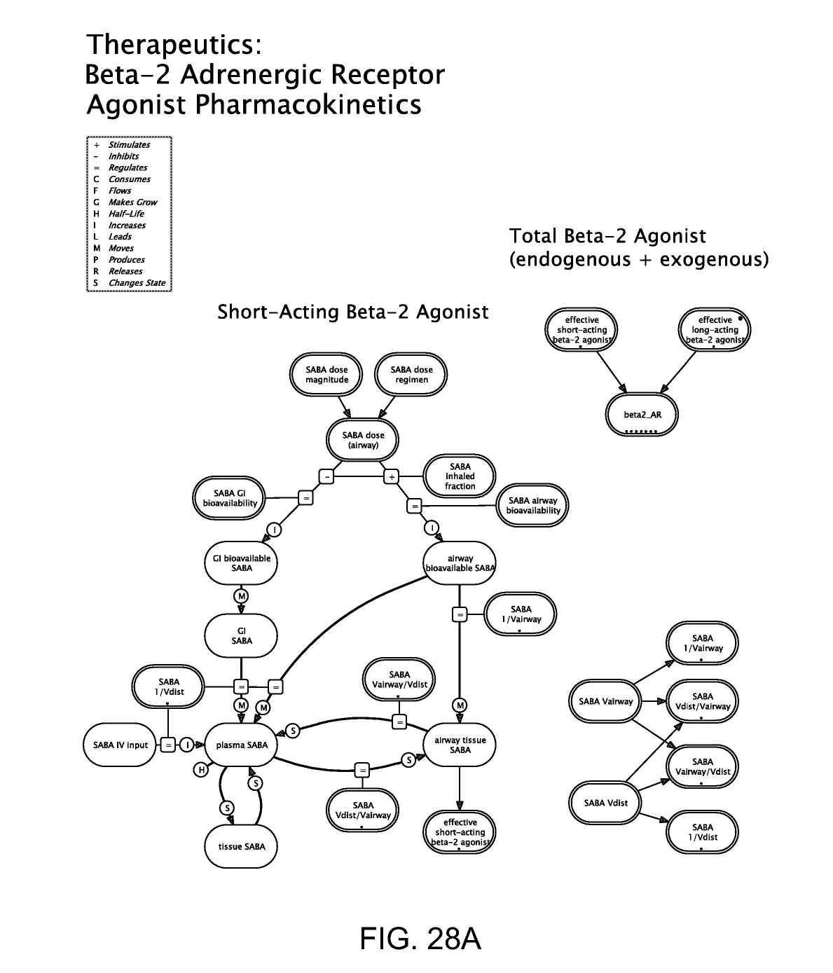

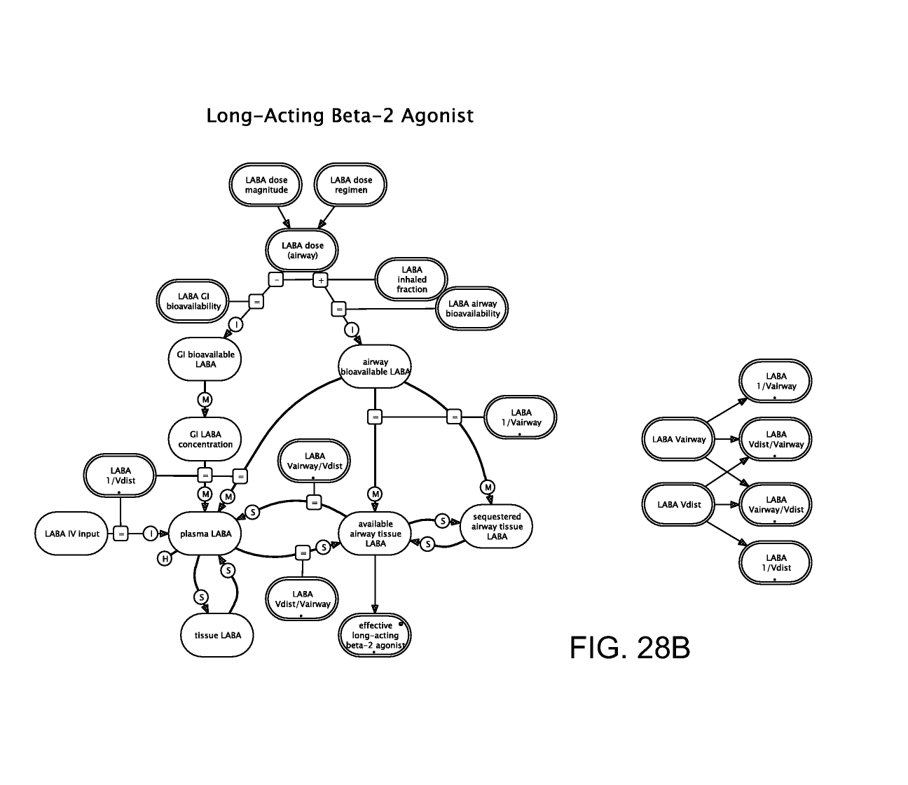

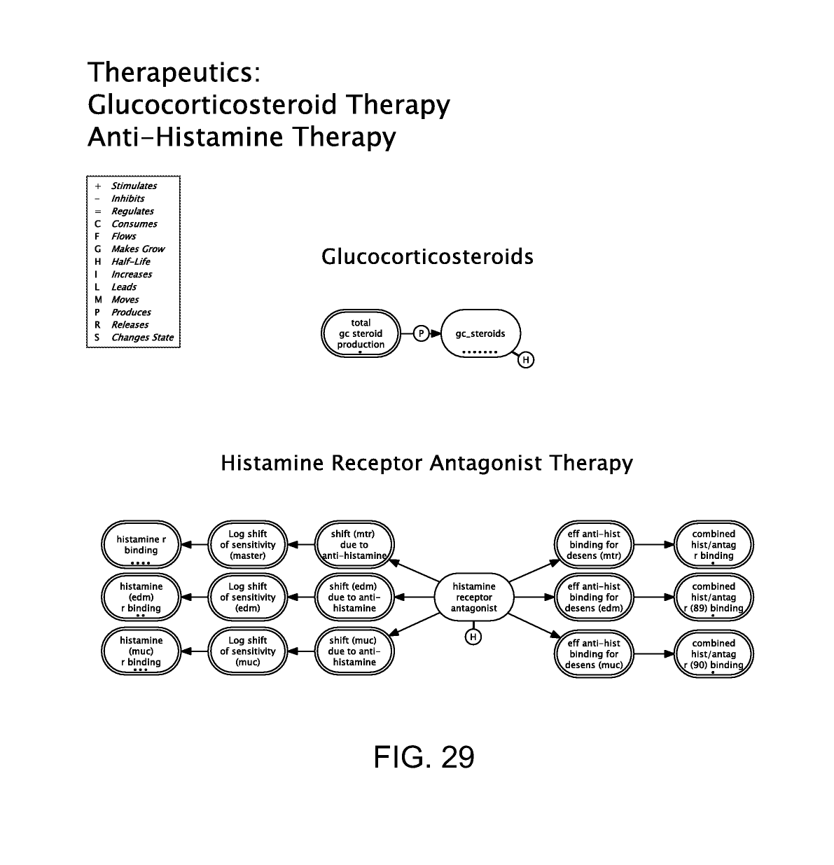

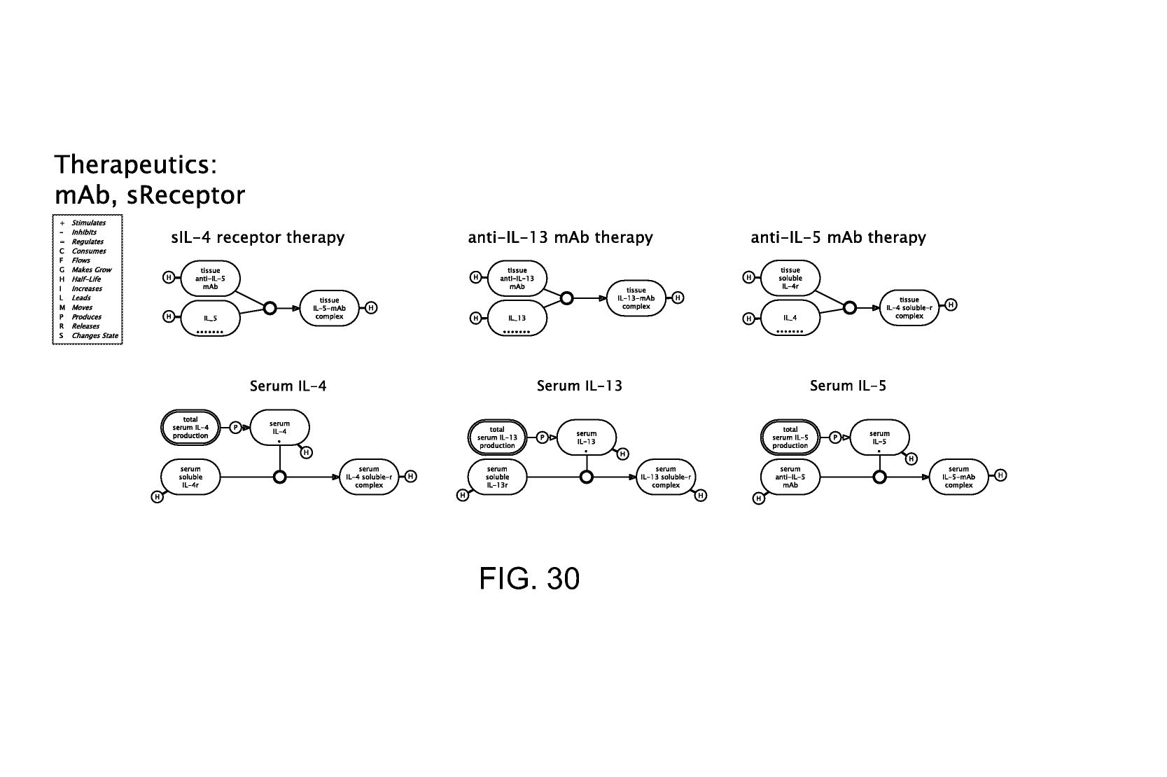

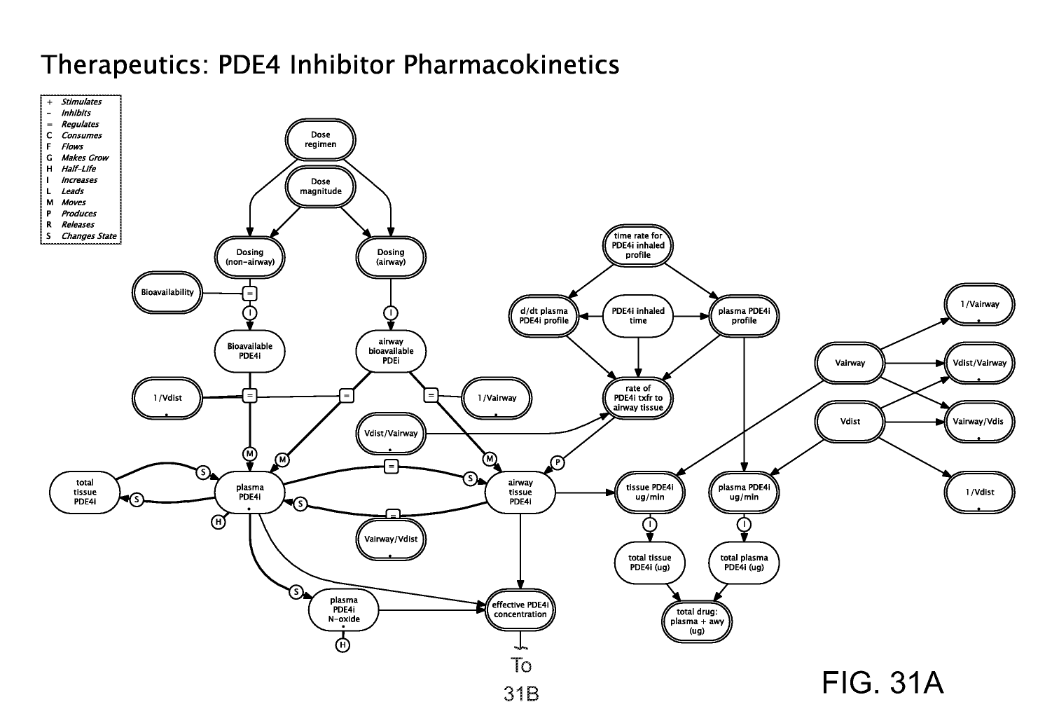

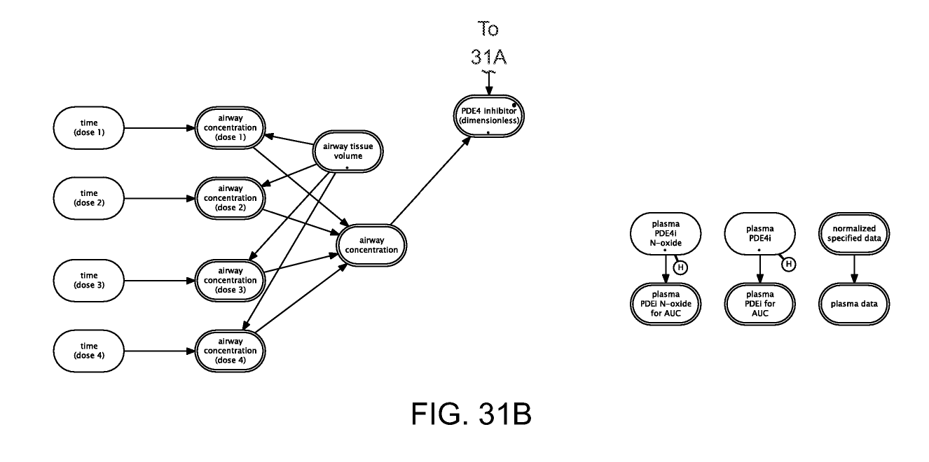

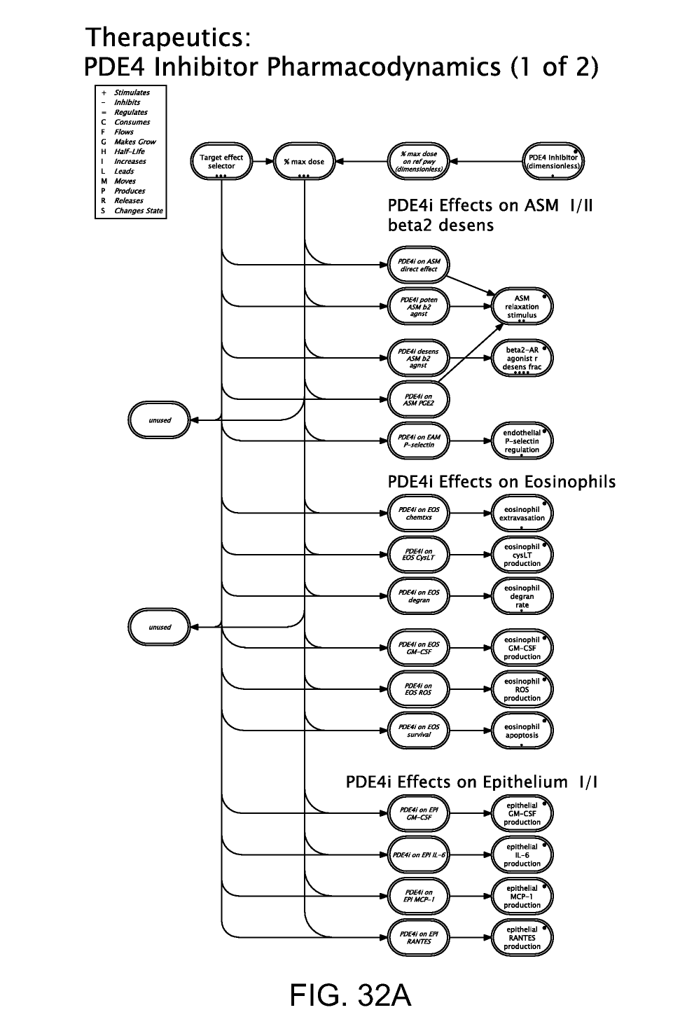

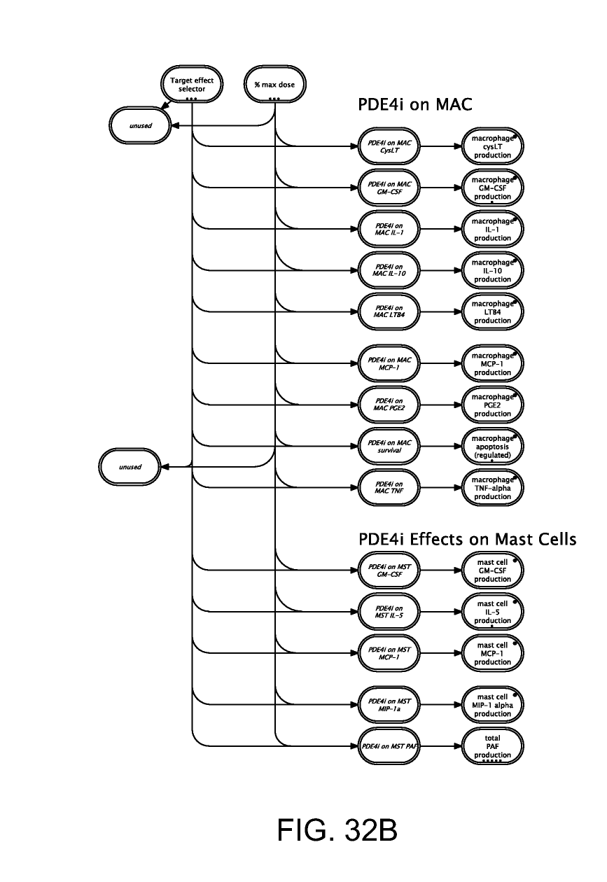

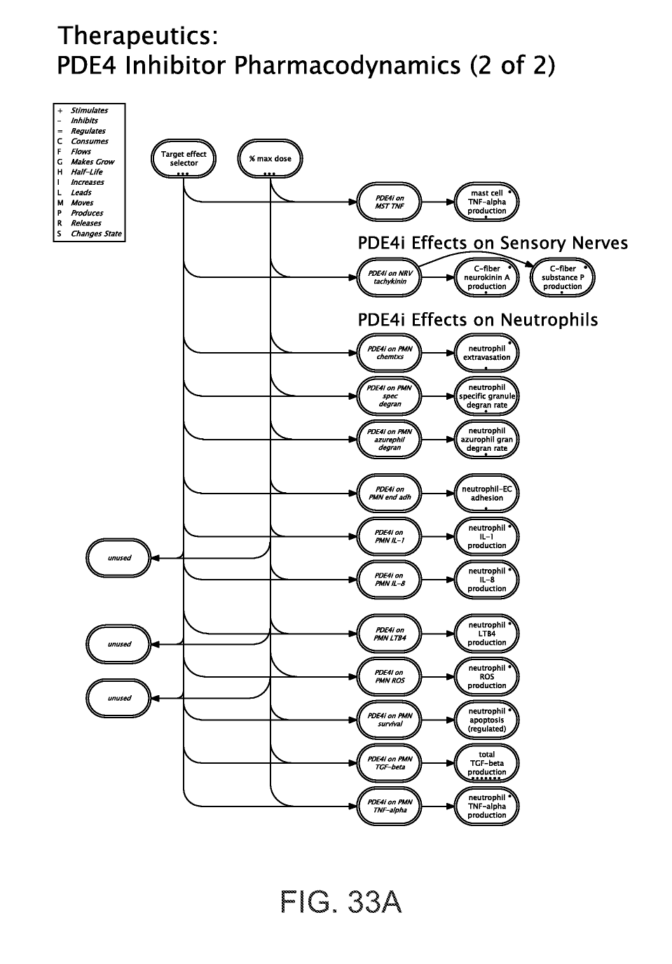

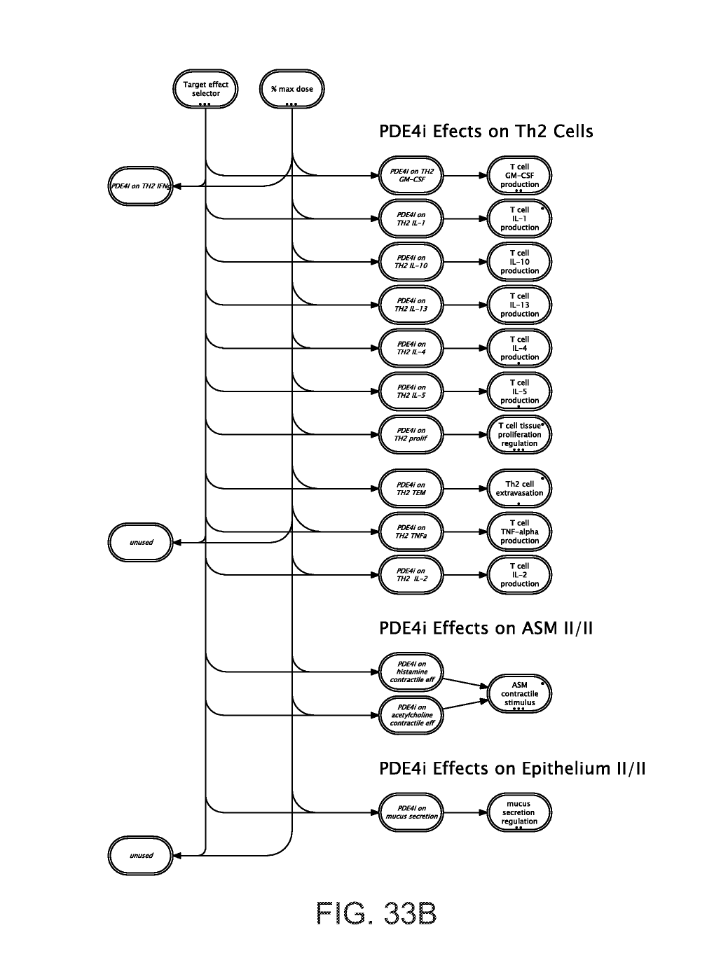

In one implementation, beta-2 adrenergic receptor (β₂-AR) agonist therapy is simulated as described in FIG. 28. Short-acting β₂-AR agonists and long-acting β₂-AR agonists may be administered directly to the airway or via the gastrointestinal (GI) tract. Each will have effects on plasma and airway levels of the β₂-AR agonists, ultimately effecting the amount of β₂-AR activity. In another implementation, glucocorticoid steroid or histamine receptor antagonist therapy can be simulated as described in FIG. 29. Various monoclonal antibody therapies can be simulated as described in FIG. 30. In yet another implementation, PDE4 inhibitor therapy is simulated as described in FIGS. 31-33.

The computer models of the invention can be used to identify one or more biomarkers. A biomarker can refer to a biological characteristic that can be evaluated to infer or predict a particular result. For instance, biomarkers can be predictive of effectiveness, biological activity, safety, or side effects of a therapy. Biomarkers can be identified to select or create tests that can be used to differentiate subjects. Biomarkers that differentiate responders versus non-responders may be sufficient if the specific goal is to identify a recommended therapy for a subject. Similarly, biomarkers can be identified to diagnose or categorize subjects. For example, utilizing the computer model of the invention, the relative contribution of obstruction and constriction to an asthmatic subject's symptoms can be determined based on FEV and the percent of reversibility of symptoms under treatment with β2 agonists. Identification of the relative contributions of obstruction and constriction can guide appropriate therapy for the subject. Further, biomarkers can be identified to monitor the actual response of a subject to a therapy.

One aspect of the invention comprises identifying one or more biomarkers by executing a computer model of the invention absent a virtual protocol to produce a first set of results; executing the computer model based on the virtual protocol to produce a second set of results; comparing the first set of results with the second set of results; and identifying a correlation between one or more variables or parameters and a virtual measurement indicative of a pre-selected biological characteristic. Preferable the correlated variable(s) and/or parameter(s) is present in only one of the first or second set of results.

Results of two or more virtual measurements can be determined to be substantially correlated based on one or more standard statistical tests. Statistical tests that can be used to identify correlation can include, for example, linear regression analysis, nonlinear regression analysis, and rank correlation test. In accordance with a particular statistical test, a correlation coefficient can be determined, and correlation can be identified based on determining that the correlation coefficient falls within a particular range. Examples of correlation coefficients include goodness of fit statistical quantity, r², associated with linear regression analysis and Spearman Rank Correlation coefficient, rs, associated with rank correlation test.

A virtual patient in the computer model can be associated with a particular set of values for the parameters of the computer model Thus, virtual patient A may include a first set of parameter values, and virtual patient B may include a second set of parameter values that differs in some fashion from the first set of parameter values. For instance, the second set of parameter values may include at least one parameter value differing from a corresponding parameter value included in the first set of parameter values. In a similar manner, virtual patient C may be associated with a third set of parameter values that differs in some fashion from the first and second set of parameter values.

A biological process that modulates biological response to the therapy can be associated with a knowledge gap or uncertainty, and various virtual patients of the computer model can be defined to represent different plausible hypotheses or resolutions of the knowledge gap. By way of example, biological processes associated with airway smooth muscle (ASM) contraction can be identified as playing a role in modulating biological response to a therapy for asthma. While it may be understood that inflammatory mediators have an effect on ASM contraction, the relative effects of the different types of inflammatory mediators on ASM contraction as well as baseline concentrations of the different types of inflammatory mediators may not be well understood. For such a scenario, various virtual patients can be defined to represent human subjects having different baseline concentrations of inflammatory mediators. Knowledge gaps can be identified and explored as described in co-pending Provisional U.S. Application No. 60/691,809, entitled “Hypothesis Sensitivity Analysis.”

What is claimed is:

1. A method for developing a model of a respiratory system of a mammal, said method comprising:
identifying one or more biological processes associated with obstruction of the respiratory system;
identifying one or more biological processes associated with constriction of the respiratory system;
mathematically representing each biological process to generate one or more dynamic representations of a biological process associated with obstruction of the respiratory system and one or more representations of a biological process associated with constriction of the respiratory system; and
combining the representations of biological processes to form a model of the respiratory system.

2. The method of claim 1, further comprising:
identifying one or more biological processes associated with biomechanical remodeling of the respiratory system;
mathematically representing each biological process associated with biomechanical remodeling to generate one or more representations of a biological process associated with biomechanical remodeling.

3. The method of claim 2, wherein the biological process associated with biomechanical remodeling of the respiratory system is a biological process associated with tissue hyperplasia, a biological process associated with airway compliance or a biological process associated with tissue compliance.

4. The method of claim 1, wherein the biological process associated with obstruction of respiratory system is a biological process associated with edema or a biological process associated with mucus.

5. The method of claim 4, wherein the biological process associated with edema is responsive to at least one of epithelial denuding, vascular permeability, and an inflammatory mediator.

6. The method of claim 4, wherein the biological process associated with mucus secretion is responsive to at least one of epithelial denuding, vascular permeability, mucus secretion, and an inflammatory mediator.

7. A computer-readable medium having computer-readable instructions stored thereon that, upon execution by a processor, cause the processor to simulate a respiratory system of a mammal, and further wherein the instructions comprise:
a) mathematically representing one or more biological processes associated with obstruction of the respiratory system of the mammal, wherein at least one representation varies in response to other biological processes;
b) mathematically representing one or more biological processes associated with constriction of the respiratory system of the mammal;
c) defining a set of mathematical relationships between the representations of biological processes to form a model of the respiratory system.

8. The computer-readable medium of claim 7, wherein the instructions further comprise mathematically representing one or more biological processes associated with biomechanical remodeling of the respiratory system.

9. The computer-readable medium of claim 7, wherein the instructions further comprise accepting user input specifying one or more parameters associated with one or more of the mathematical representations.

10. The computer-readable medium of claim 7, wherein the instructions further comprise accepting user input specifying one or more variables associated with one or more of the mathematical representations.

11. The computer-readable medium of claim 7, wherein the instructions further comprise applying a virtual protocol to the model of the respiratory system.

12. The computer-readable medium of claim 11, wherein the virtual protocol represents a therapeutic regimen, a diagnostic procedure, passage of time, exposure to environmental toxins, or physical exercise.

13. The computer-readable medium of claim 7, wherein the instructions further comprise defining one or more virtual patients.

14. A method of simulating a respiratory system of a mammal, said method comprising executing a computer model of a respiratory system according to the claim 7.

15. The method of claim 14, further comprising applying a virtual protocol to the computer model to generate a set of outputs representing a phenotype of the biological system.

16. The method of claim 15, wherein the virtual protocol comprises a therapeutic regimen, a diagnostic procedure, passage of time, exposure to environmental toxins, or physical exercise.

17. The method of claim 15, wherein the phenotype represents a diseased state.

18. The method of claim 14, further comprising accepting user input specifying one or more parameters or variable associated with one or more mathematical representations prior to executing the computer model.

19. The method of claim 18, wherein the user input comprises a definition of a virtual patient.

20. A system, comprising:
a) a processor including computer-readable instructions stored thereon that, upon execution by a processor, cause the processor to simulate a respiratory system of a mammal, the computer readable instructions comprising:
i) mathematically representing one or more biological processes associated with obstruction of the respiratory system of the mammal;
ii) mathematically representing one or more biological processes associated with constriction of the respiratory system of the mammal;
iii) defining a set of mathematical relationships between the representations of biological processes associated with obstruction and representations of biological processes associated with constriction;
iv) applying a virtual protocol to the set of mathematical relationships to generate a set of outputs;
b) a first user terminal, the first user terminal operable to receive a user input specifying one or more parameters associated with one or more mathematical representations defined by the computer readable instructions; and
c) a second user terminal, the second user terminal operable to provide the set of outputs to a second user.
